(19) United States
(12) Patent Application Publication
(10) Pub. No.: US 2024/0281765 A1
(43) Pub. Date: Aug. 22, 2024

(54) AFFORDABLE HOUSING APPLICATION FOR REMOTE ELECTRONIC CERTIFICATION

(71) Applicant: Christyn Bowen, Anza, CA (US)

(72) Inventor: Christyn Bowen, Anza, CA (US)

(21) Appl. No.: 18/619,144

(22) Filed: Mar. 27, 2024

Related U.S. Application Data
(63) Continuation-in-part of application No. 17/903,356, filed on Sep. 6, 2022, now Pat. No. 11,972,439.
Application No. 17/903,356 is a continuation-in-part of application No. 17/507,047, filed on Oct. 21, 2021, now abandoned.
(60) Provisional application No. 63/180,189, filed on Apr. 27, 2021.

(51) Int. Cl. G06Q 10/10; G06Q 50/16

(52) U.S. Cl. CPC G06Q 10/10; G06Q 50/16

(57) ABSTRACT

A computer implemented system for remote certification of applicants and tenants for eligibility in an affordable housing program. A machine learning algorithm is trained using labelled input and output training data to produce an AI model that detects errors or discrepancies in answers provided by an applicant or tenant. The AI model is trained on standards and requirements of the housing program and automatically determines eligibility or ineligibility of a household by applying the standards and requirements to the answers of the applicant. The AI model may verify continued eligibility for a certification after receiving a notification of a household change. The AI model is trained to detect fraud and inaccuracies from data received from third parties pertaining to an applicant's or tenant's eligibility.

### CROSS-REFERENCE TO RELATED APPLICATIONS

This application is a continuation-in-part of U.S. non-provisional application Ser. No. 17/903,356, filed on Sep. 6, 2022, which is a continuation-in-part of U.S. non-provisional application Ser. No. 17/507,047, filed Oct. 21, 2021, which claims priority to U.S. provisional application No. 63/180,189, filed on Apr. 27, 2021, which applications are hereby incorporated by reference.

### FIELD OF THE DISCLOSURE

The present invention relates to a system and method for remotely completing a certification process for an affordable housing program.

### BACKGROUND

There are many different types of affordable/low-income housing programs available in the U.S. Some housing programs are part of federal programs such as the U.S. Department of Housing and Urban Development (HUD) that offer and manage housing programs to assist individuals in finding housing in participating public or private housing facilities. States also offer affordable/low-income housing programs, which are sometimes referred to as low-income housing tax credit (LIHTC) programs. Some programs combine aspects of federal and state housing programs and are referred to as a blended housing program.

Regardless of the type of housing program, the certification process for proving that a resident or applicant is eligible or ineligible for the housing program is typically a complex, arduous, and difficult process for both the resident or applicant and the property management. Before move-in, an applicant must show eligibility for the housing program by completing lengthy questionnaires and forms (typically 20-100 pages or longer) with questions about income and assets of the applicant and other household members. Applicants must also provide documentary proof of income, assets, and eligibility status, such as bank statements, paystubs, court documents related to child support and marital status, and other related documents.

Compliance specialists and property management may assist the applicant in completing the questionnaires and forms and obtaining documents required to complete the certification process. The certification process may require multiple on-site, in person visits between the applicant, property management, and compliance specialists. Each visit may take several hours and may include additional trips to employers, banks, and other locations to obtain verification and documentation required to participate in the housing program.

Property management must confirm that the certification process is completed correctly for each resident in the housing program or risk government penalties. The certification process must occur every time a new resident moves in who pays no rent or reduced rent as part of their inclusion in the housing program, and at least once a year thereafter in a recertification process. Some affordable housing programs offered by HUD require recertification any time there is any change to income, assets, and other eligibility considerations of a household, which means that recertification may occur multiple times per year, meaning that a resident may have to endure the lengthy, arduous process of filling out all required questionnaires and forms and obtaining all necessary documents more than once a year. For most residents and application, the way in which the certification process is currently completed, requiring in person, on-site visits and physical forms and documents, is an antiquated and dreaded process. The amount of time and energy spent by property managers to complete mass certifications for multiple applicants and residents is not insignificant. For applicants and residents who are disabled, elderly, or have other considerations, it is not easy to go back and forth to the offices of their property managers and compliance specialists to complete each step and task of the certification process. The ongoing worldwide pandemic due to COVID-19 makes it even harder and riskier for individuals to meet in person to complete the certification process.

Accordingly, there is a need for an improved system and method for applicants to an affordable housing program and property managers to complete the required certification process.

### SUMMARY

According to some aspects of this disclosure, a system for validating a remote certification for a housing program is provided. The system comprises a processor and a memory coupled to the processor and storing instructions configured to cause the processor to implement a housing application. The housing application presents an interface to an applicant to enable the applicant to provide information required to complete the certification. A machine learning algorithm is trained using labelled input training data and labelled output training data to produce an artificial intelligence (AI) model that detects errors or discrepancies in answers provided by the applicant.

Questions are presented to the applicant through the application that correspond to fillable fields in associated questionnaires, forms, or documents. Answers from the applicant to the questions are received via the application and analyzed by the AI model for errors or discrepancies. If errors or discrepancies are found, the applicant is notified of the errors or discrepancies and providing with access to a report that lists the errors or discrepancies. Next, second questions are presented to the applicant that also correspond to the fillable fields in the associated questionnaires, forms, or documents, but in a different order or manner. Updated answers are received from the applicant, and correct answers are extracted from the updated answers and mapped to the fillable fields in the associated questionnaires, forms or documents.

The AI model may initiate a certification process to verify continued eligibility for the certification after receiving a notification of a household change from the applicant. The AI model may review the household change and notify the applicant as to whether the applicant has continued eligibility for the certification. The AI model may review the updated answers to determine whether verification or documentation of a third party needed for the certification has been provided. If the verification or documentation of the third party has not been provided, automated requests are sent to the third party for the verification or documentation. To prevent fraud, the AI model may flag discrepancies and initiate reviews, such as by conducting a one-on-one video conference meeting with the tenant.

Verification or documentation received from third parties is stored and labeled as relating to income verification, asset verification, or employment verification. For documents labeled as relating to asset verification, income verification, or employment verification, the interface displays a name of the document, the type of certification, individuals who can access the document, a status of the document, and an ability to edit the document. A completed set of questionnaires, forms, or documents to be submitted for the certification is assembled and stored for future auditing.

In some implementations, the AI model is trained on standards and requirements of the affordable/low-income housing program and automatically determines eligibility of a household by applying the standards and requirements to the received answers.

In some implementations, the AI model automatically notifies any third party that needs to provide third party verifications and documentation.

In some implementations, the AI model analyzes household changes and if appropriate automatically initiates the certification process.

In some implementations, the AI model serves as an interactive guide, offering users guidance on the affordable/low-income housing program in which the tenant is applying or participating.

In some implementations, the machine learning algorithm comprises a recurrent neural network (RNN) with long short-term-memory (LSTM) cells.

In some implementations, the machine learning algorithm comprises a regression model that infers annual income based on pay frequencies and pay rates and to assess eligibility against housing program requirements.

Other features, aspects, and advantages of this disclosure will be apparent from the following description, drawings, and appended claims.

### BRIEF DESCRIPTION OF THE DRAWINGS

Embodiments of this disclosure are described below with reference to the drawings. The drawings are provided to illustrate selected embodiments only and not all possible implementations, and do not limit the scope of this disclosure.

FIG. 1 is a block diagram of an exemplary computing device and components of a computer-implemented system that includes an affordable housing application, in accordance with aspects of this disclosure.

FIG. 2 is a block diagram of users and components of a system utilizing the affordable housing application.

FIG. 3 is a pictorial illustration of users of the system utilizing the affordable software application.

FIG. 4 is a pictorial illustration of one or more interfaces of the affordable housing application available to a resident/applicant.

FIG. 5 is a pictorial illustration of one or more interfaces of the affordable housing application available to property management.

FIG. 6 is a pictorial illustration of one or more interfaces of the affordable housing application available to a compliance specialist.

FIG. 7 is a pictorial illustration of one or more interfaces of the affordable housing application available to an administrator.

FIG. 8 is a pictorial illustration of an exemplary checklist that may be implemented by the affordable housing application.

FIG. 9 is a pictorial illustration of a first page of an exemplary questionnaire associated with the affordable housing application.

FIG. 10 is a pictorial illustration of a second page of the exemplary questionnaire of FIG. 9.

FIG. 11 is a pictorial illustration of an interface of the affordable housing application displaying a questionnaire for a particular certification type.

FIG. 12 is a pictorial illustration of an interface of the affordable housing application for displaying and editing certifications relating to residents/applicants.

FIG. 13 is a pictorial illustration of an interface of the affordable housing application showing comments provided as part of the remote certification process.

FIG. 14 is a pictorial illustration of an interface of the affordable housing application displaying information related to a resident/applicant.

FIG. 15 is a pictorial illustration of an interface of the affordable housing application displaying electronic forms that may be edited as part of the remote certification process.

FIG. 16 is a pictorial illustration of an interface of the affordable housing application displaying status updates for any electronic forms.

FIG. 17 is a pictorial illustration of an interface of the affordable housing application displaying status and information for electronic forms including the group type of certification.

FIG. 18 is a pictorial illustration of an interface of the affordable housing application displaying electronic forms that have been approved but still require signatures.

FIG. 19 is a pictorial illustration of an interface of the affordable housing application displaying relevant data pertaining to a particular file.

FIG. 20 is a flowchart of an exemplary method implemented by the affordable housing application.

FIG. 21 is a flowchart showing additional steps of the exemplary method implemented by the affordable housing application.

FIG. 22 is a block diagram conceptually illustrating additional components of the affordable housing application.

FIG. 23 is a flowchart of an exemplary method implemented by the affordable housing application.

FIG. 24 is a block diagram that conceptually illustrates training and deployment of an AI model in the affordable housing application.

### DETAILED DESCRIPTION

This description is drawn to an innovative computer implemented system for electronic completion of housing certifications that can eliminate in-person certification appointments and multiple visits to a physical office. The system includes third-party automated and manual verification processes, certification automation based on a household's due date, 24/7 certification assistance, and storage of completed electronic certifications for future reference by property management, a resident/applicant, a compliance specialist, or an administrator.

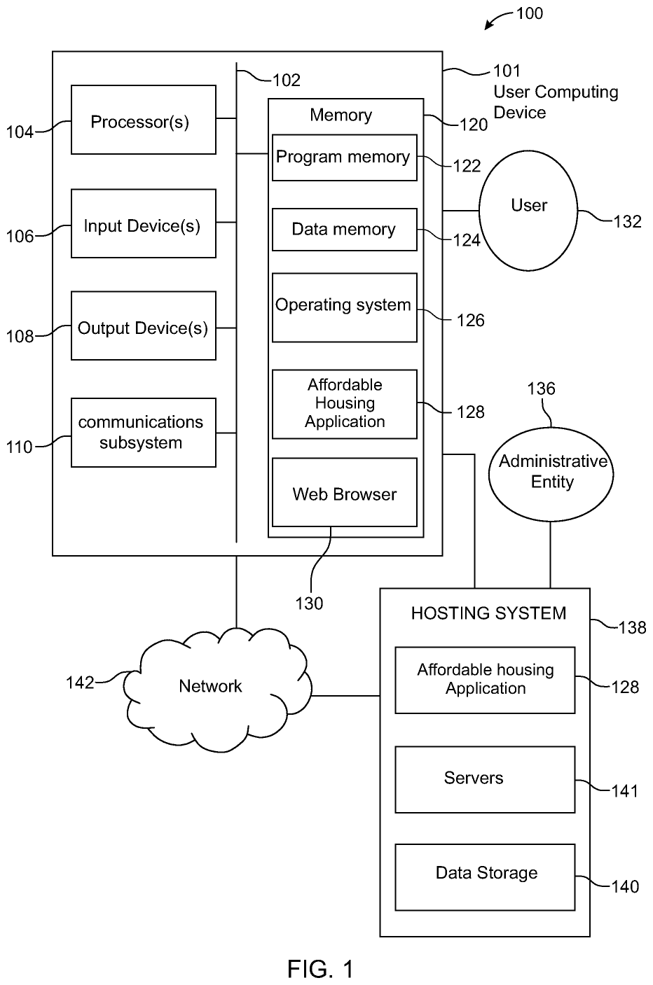

FIG. 1 is a block diagram of an exemplary system 100 comprising computing device 101 that includes affordable housing software application 128, in accordance with aspects of this disclosure. FIG. 1 is only a generalized illustration of various components of system 100, any or all of which may be utilized as appropriate, and broadly illustrates how individual system elements may be implemented in a relatively separated manner or in a relatively more integrated manner.

Computing device 101 of system 100 may be any type of computing device known or created in the future including, without limitation, fixed in place computers, such as desktop computers, and mobile computing devices. Mobile computing devices may include, but are not limited to, laptop computers, smartphones, mobile phones, tablets, wearable electronic computing devices such as watches or glasses, or any other type of mobile computing device. Further, computing device 101 may include televisions that are not necessarily mobile and may be attached to or positioned on furniture or to a wall or another fixture. Computing device 101 can perform the methods described herein and can function as a host computer system, a remote kiosk/terminal, a point-of-sale device, a mobile device, a set-top box, or any other computer system.

Computing device 101 may be any type of computing device or information handling system from small handheld computers/mobile telephones to large mainframe computers. Some non-limiting examples of handheld computing devices include personal digital assistants (PDAs), personal entertainment devices, MP3 players, portable televisions, and compact disc players. Other non-limiting examples of computing devices 101 include laptops, notebooks, workstation computers, personal computer systems, and servers (e.g., servers 141). Computing devices 101 may be used by the various parties described herein and may be connected on a computer network, such as computer network 142. Non-limiting examples of computer networks that may be used to interconnect the various information handling systems include local area networks (LANs), wireless local area networks (WLANs), the Internet (e.g., World Wide Web), the public switched telephone network (PSTN), other wireless networks, and any other network topology that can interconnect information handling systems.

Computing device 101 may comprise hardware elements that are electrically coupled via bus 102 (or otherwise in communication, as appropriate). The hardware elements of computing device 101 may include one or more processors 104, including without limitation one or more general-purpose processors and/or one or more special-purpose processors (such as digital signal processing chips, graphics acceleration processors, and the like). Computing device 101 further comprises one or more input devices 106, such as (without limitation) cameras, sensors (including inertial sensors), a mouse, a keyboard, and the like, that may be utilized in the implementation of affordable housing application 128.

Computing device 101 may further include one or more output devices 108 such as a device display. In some embodiments, input device 106 and output device 108 may be integrated, for example, in a touch screen or capacitive display as commonly found on mobile computing devices, desktop computers, and laptops.

Processors 104 may have access to a memory such as memory 120. Memory 120 may include various hardware devices for volatile and non-volatile storage and may include both read-only and writable memory. For example, memory 120 may comprise random access memory (RAM), central processing unit (CPU) registers, read-only memory (ROM), and writable non-volatile memory, such as flash memory, hard drives, floppy disks, CDs, DVDs, magnetic storage devices, tape drives, device buffers, and so forth. Memory 120 is non-transitory and is not a propagating signal divorced from underlying hardware. Memory 120 may include program memory 122 for storing programs and software, such as operating system 126, affordable housing application 128, and other programs and software. Memory 120 may also include data memory 124 for storing database query results, configuration data, settings, user options or preferences, etc., that are provided to program memory 122 or any other element of computing device 101.

Computing device 101 may include (and/or be in communication with) additional non-transitory storage devices such as, without limitation, local and/or network accessible storage, a disk drive, a drive array, an optical storage device, a solid-state storage device such as a random access memory (“RAM”) and/or a read-only memory (“ROM”), which can be programmable, flash-updateable and the like. Such storage devices may be configured to implement any appropriate data storage, including without limitation, various file systems, database structures, and the like. The storage devices may be non-volatile data storage devices in some embodiments. Computing device 101 may be able to access removable nonvolatile storage devices that can be shared among two or more information handling systems (e.g., computing devices) using various techniques, such as connecting the removable nonvolatile storage device to a USB port or other connector of the information handling systems.

Computing device 101 may include communications subsystem 110, which may comprise (without limitation) a modem, a wired or wireless network card, an infrared communication device, a wireless communication device and/or chipset (such as a Bluetooth™ device, an 802.11 device, a WiFi device, a WiMax device, cellular communication facilities, etc.), and the like. Communications subsystem 110 may permit data exchange with a network (e.g., such as network 142), other computer systems, and other devices.

Computing device 101 and system 100 may comprise software elements, shown as located within memory 120, such as operating system 126, device drivers, executable libraries, and other code, which may comprise computer programs provided by various embodiments, and may implement methods and configure systems provided by other embodiments. By way of example, one or more methods described herein may be implemented as code or instructions executable by a computer or a processor within a computer. Such code or instructions may be used to configure or adapt computing device 101 to perform one or more methods described herein.

A set of such instructions or code may be stored on a computer-readable storage medium incorporated within or separate from computing device 101 (e.g., a removable medium, such as a compact disc or USB stick), or provided in an installation package, such that the storage medium can be used to program, configure, or adapt a general-purpose computer with the instructions/code stored thereon. These instructions might take the form of code that is executable by computing device 101 or source or installable code that, upon compilation and/or installation on computing device 101 (using any of a variety of generally available compilers, installation programs, compression/decompression utilities, etc.), then takes the form of executable code.

Substantial variations may be made in accordance with specific requirements. For example, customized hardware may be used, and particular elements may be implemented in hardware, software (including portable software, such as applets, etc.), or both. Further, connection to other computing devices such as network input/output devices may be employed.

Some embodiments may employ a computer system such as computing system 100 to perform methods in accordance with the disclosure. For example, some of the described methods may be performed by computing device 101 in response to processor(s) 104 executing sequences of instructions that may be incorporated into operating system 126 or stored in memory 120. Such instructions may be read into memory 120 from another computer-readable medium or storage device.

The terms “machine-readable medium” and “computer-readable medium,” as used herein, refer to any medium that participates in providing data that causes a machine to operate in a specific fashion. Various computer-readable media might be involved in providing instructions/code to processor(s) 104 for execution and storing such instructions/code. A computer-readable medium may be a physical and/or tangible storage medium and may take many forms, such as non-volatile media, volatile media, and transmission media. Non-volatile media may include, for example, optical and/or magnetic disks which may be an example of storage devices. Volatile media may include, for example, dynamic memory, which may be a type of memory included in memory 120. Transmission media may include, for example, coaxial cables, copper wire, and fiber optics, including the wires that comprise bus 102 and various components of communications subsystem 110 (and/or the media by which communications subsystem 110 provides communication with other devices). Transmission media may also take the form of waves such as radio, acoustic, and light waves that may be generated during radio-wave and infrared data communications.

Common forms of physical and tangible computer-readable media include, for example, floppy disks, flexible disks, hard disks, magnetic tapes, or other magnetic mediums, CD-ROMs or other optical mediums, other physical mediums with patterns of holes, RAMs, PROMs, EPROMs, FLASH-EPROMs, other memory chips or cartridges, or any other medium from which a computer can read instructions or code.

Various forms of computer-readable media may be involved in carrying sequences of instructions to processor(s) 104 for execution. For example, the instructions may initially be carried on a magnetic or optical disc of a remote computer. The remote computer may load the instructions into its dynamic memory and send the instructions as signals over a transmission medium to be received and executed by computer system 100. These signals, which may be in the form of electromagnetic signals, acoustic signals, optical signals and the like, are examples of carrier waves on which instructions may be encoded, in accordance with various embodiments.

Communications subsystem 110 and its components generally receive the signals, and bus 102 then carries the signals (and the data, instructions, etc. carried by the signals) to memory 120, from which processor(s) 104 retrieves and executes the instructions. The instructions received by memory 120 may optionally be stored on a non-transitory storage device before or after execution by processor(s) 104.

In one or more embodiments, computing device 101 is in communication with one or more networks, such as network 142. Network 142 may include a local area network (LAN) such as a company Intranet, a metropolitan area network (MAN), or a wide area network (WAN) such as the Internet or World Wide Web. Network 142 may be a private network, a public network, or a combination thereof. Network 142 may be any other known type of network including a telecommunications network, a wireless network (including Wi-Fi), and a wireline network. Network 142 may include mobile telephone networks utilizing any protocol or protocols to communicate among mobile digital computing devices (e.g., computing device 101), such as GSM, GPRS, UMTS, AMPS, TDMA, or CDMA. In some embodiments, different types of data may be transmitted via network 142 via different protocols. In some embodiments, computing device 101 may act as a standalone device or may operate as a peer machine in a peer-to-peer or distributed network environment.

Network 142 may further include a system of terminals, gateways, and routers. Network 142 may employ one or more cellular access technologies such as 2G, 3G, 4G, 5G, LTE, global system for mobile communication (GSM), general packet radio services (GPRS), enhanced data GSM environment (EDGE), and other access technologies that may provide broader coverage between computing devices if, for instance, they are in a remote location not accessible by other networks.

Computing device 101 may include a web browser 130 that accesses one or more web applications that are accessible by network 142 and may be located on the Internet or World Wide Web. Web browser 130 may include a variety of hardware, software, and firmware generally operative to present a web application to a user via output device 108 (e.g., touchscreen, monitor, or display device). Non-limiting examples of suitable web browsers include MICROSOFT EXPLORER, MOZILLA FIREFOX, and APPLE SAFARI. Web browser 130 may be previously installed by a manufacturer or company associated with computing device 101, or may be downloaded onto computing device 101. Web browser 130 may be stored in a separate storage device or memory 120.

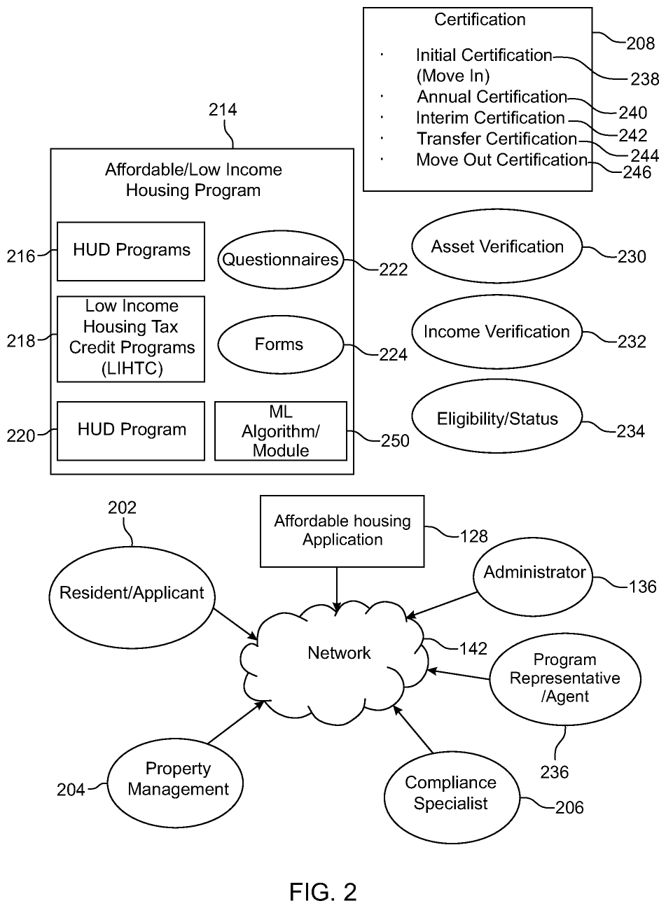

In one or more non-limiting embodiments, affordable housing application 128 is a software program or module configured to allow user 132 to remotely and electronically complete one or more certification processes. Affordable housing application 128 allows user 132 to upload all required affordable housing program documents to complete certification electronically (through affordable housing application 128). Affordable housing application 128 is particularly useful for completing electronic certifications for applicants/residents who reside at an apartment or other facility that is part of a federal, state, or other affordable or low-income housing program. As shown in FIG. 2, affordable housing application 128 is accessible by applicant/resident 202, property management 204, compliance specialists 206, and administrators/administrative entity 136.

In some embodiments, affordable housing application 128 may be implemented as a downloadable program or application storable on user computing device 101 for easy accessibility and viewability. Affordable housing application 128 may alternatively be implemented as a web service that is designed to implement a set of tasks accessible from multiple computing devices, such as computing device 101 over network 142. In one example, affordable housing application 128 is implemented as a web service accessible using the World Wide Web, although any other type of network including cellular networks may be used. Thus, user 132 may download affordable housing application 128 on computing device 101 and use input devices 106 to enter data pertinent to the user's housing application. Output device 108 (e.g., a display screen) may display pertinent forms, images, instructions, and fields viewable in the affordable housing application 128.

User 132 may invoke a series of web service calls via requests to servers 141 of hosting system 138 that may host affordable housing application 128. In some embodiments, hosting system 138 is a cloud-based type hosting system. “Cloud-based” refers to applications (such as affordable housing application 128), services, or other resources made available on demand via network 142 from a server of a cloud computing provider to user 132. Administrative entity 136 may be the cloud computing provider and provide access to servers 141, data storage systems 140, and other systems in conjunction with operation and maintenance of affordable housing application 128. Data storage systems 140 may provide access to stored data by applications running on computing device 101, which may be geographically separate from each other, may provide offsite data backup and restore functionality, may provide additional data storage and storage functionality to computing device 101.

Hosting system 138 may be implemented as a web service in some embodiments, with a corresponding set of web service application programming interfaces (APIs). The web service APIs may be implemented, for example, as a representational state transfer (REST)-based hypertext transfer protocol (HTTP) interface or as a simple object access protocol (SOAP)-based interface. Any suitable programming language may be used to create and operate affordable housing application 128 as a web service, including without limitation .Net, Java, and XML. Further, affordable housing application 128 as a web service may use standardized industry protocol for communication and may include well-defined protocols such as service transport, XML messaging, service description, and service discovery layers in the web services protocol stack. Hosting system 138 may be implemented by one or more servers 141 and such that client applications (such as those executing on computing device 101) can store, retrieve, or otherwise manipulate data objects in hosting system 138.

In some embodiments, administrative entity 136 is the provider and creator of affordable housing application 128. Administrative entity 136 may make affordable housing application 128 available to any client or user, such as user 132, who wants to use the features of affordable housing application 128. Administrative entity 136 may manipulate and alter affordable housing application 128 remotely to affect operation and maintenance of affordable housing application 128 as stored on servers 141 and/or data storage devices 140. While administrative entity 136 is depicted in FIG. 1 as a single entity communicating over network 142 through hosting system 138, administrative entity 136 may alternatively be distributed over network 142 in multiple physical locations.

In some embodiments, affordable housing application 128 is a downloadable software module that may be downloaded and stored directly on computing device 101 and that may be accessible from the cloud or another system via network 142. Accordingly, affordable housing application 128 may be downloaded onto computing device 101 as a computer-based application and software module that runs on computing device 101. In some embodiments, affordable housing application 128 is preinstalled on computing device 101 by a manufacturer, designer, or other entity. Affordable housing application 128 may be built or otherwise integrated into existing platforms such as (without limitation) a website, a third-party program, iOS™, Android™, Snapchat™, Getty Images™, Instagram™, Facebook™, or any other platform capable of transmitting, receiving, and presenting data.

Affordable housing application 128 may be stored on computing device 101 and may also be stored on or otherwise accessible by servers 141 over network 142. Computing device 101 comprises memory 120 storing instructions that when executed by processors 104 causes computing device 101 to perform operations to implement affordable housing application 128.

FIG. 2 is a pictorial illustration of various components of system 100 including affordable housing application 128. Affordable housing application 128 aids in the certification process 208 required to ensure that residents/applicants 202 are eligible for a specific type of affordable housing program 214 and are in compliance with its guidelines. The terms “affordable housing” and “low-income” are used interchangeably throughout this description. Affordable housing application 128 is also useful to property management 204 to ensure that their applicants/residents 202 are eligible for and in compliance with affordable housing program 214. Property management 204 as well as applicants/residents 202 may face significant fines if certification process 208 is not complied with including providing all necessary documentation to qualify and remain eligible for certification 208.

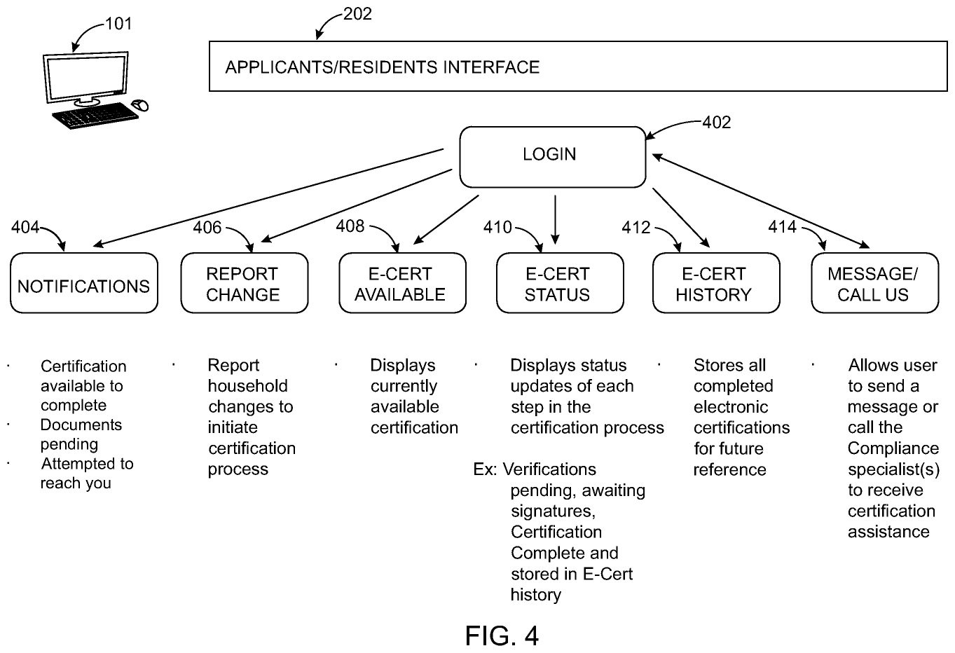

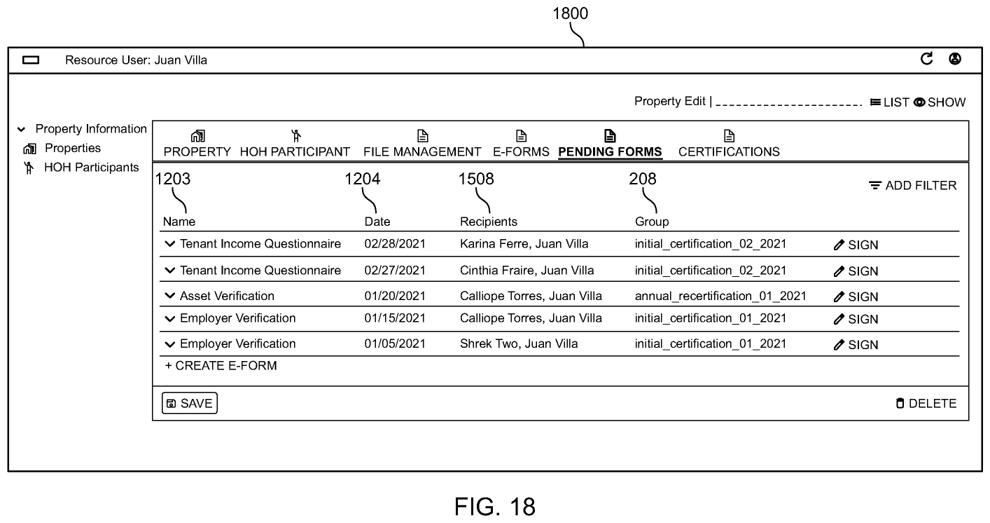

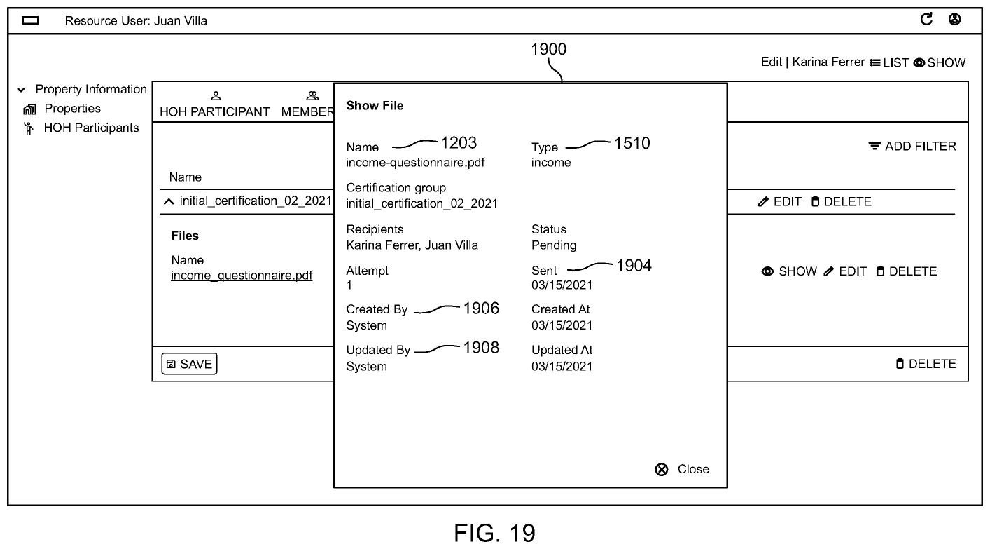

Resident/applicant 202, property management 204, compliance specialist 206, administrator 136, and program representative/agent 236 may access affordable housing application 128 as a web service from computing device 101 over network 142. Each of these parties may have various reasons for using affordable housing application 128 for remote and electronic certification process 208. Affordable housing application 128 may alternatively be downloaded and stored as a software program on the computing device 101. FIGS. 4-19 illustrate various features and functions offered by affordable housing application 128 to resident/applicant 202, property management 204, compliance specialist 206, administrator 136, and program representative/agent 236.

Resident/applicant 202 refers to the applicant, tenant, or resident of an affordable/low-income housing program 214. In this regard, the terms “applicant”, “tenant”, and “resident” are interchangeably herein.

Property management 204 refers to a party that manages or runs a residential facility, complex, or location, such as a house, apartment, condo, or other type of residence. Property management 204 may include leasing managers and staff working for or owning a property, and may include private and public landlords.

Compliance specialist 206 is a specialized and qualified individual that confirms that resident/applicant 202 is in compliance with all requirements and the certification process 208 for a particular housing program 214. Compliance specialist 206 is knowledgeable in issues related to eligibility guidelines, rent calculations, income and asset guidelines, allowances and adjusted income guidelines, eligibility verification, billing, screening guidelines, re-certification, claims and fraud, and guideline changes such as income calculations and reporting procedures. Compliance specialist 206 may confirm that applicant/resident 202 and property management 204 are in compliance with the certification guidelines for housing program 214. In some cases, property management 204 may work with compliance specialist 206 rather than confirming compliance on their own. Compliance specialist 206 may be an employee or contractor hired by property management 204 to ensure compliance with guidelines for housing program 214.

Administrator 136 manages and operates affordable housing application 128 on behalf of its users such as resident/applicant 202, property management 204, compliance specialist 206, and representative/agent 236. Administrator 136 may have add or edit accounts for these or any other users.

Representative/agent 236 may represent affordable/low-income housing program 214, regardless of whether housing program 214 is run by a government agency, a private agency, or a combination thereof. Representative/agent 236 may remotely view and audit documents and other items related to any type of certification 108, including an initial certification 238, an annual certification 240, an interim certification 242, a transfer certification 244, and a move out certification 246.

Initial certification 238 may occur when resident/applicant 202 first or initially moves into an affordable housing location and is eligible to participate in housing program 214. Annual certification 240 is required each year and may be at a particular date and time to ensure that resident/applicant 202 is still eligible and qualifies to be enrolled in housing program 214. Each resident/applicant 202 must annually re-certify that their information is correct and consistent as stated on their initial application forms. Current income and family composition, for example, may be considered to determine whether resident/applicant 202 remains eligible for housing program 214. Transfer certification 244 may be needed to transfer resident/applicant 202 to another housing program 214. Move out certification 246 must occur when applicant/resident 202 moves out of an affordable housing/low-income housing location. Some or all of certifications 208 may be required by law and may subject resident/applicant 202 and property management 204 to fines and penalties if not completed.

Thus, resident/applicant 202 and property management 204 must comply with many legal and certification requirements for a particular affordable/low-income housing program 214. Because each type of certification 208 has its own forms, questionnaires, status updates, and documents, timelines, and deadlines, it can become an overwhelming and time consuming process. Further, current systems do not allow for remote certification and require resident/applicant 202 to meet in person with property management 204 and/or compliance specialist 206 to complete and sign questionnaires 222, forms 224, and other documents necessary to complete certifications 208, which puts a burden on resident/applicant 202 to find time and manage resources to travel to and meet with property management 204 and/or compliance specialist 206.

Affordable/low-income housing program 214 may include, without limitation, federally-based department of housing and urban development (HUD) programs 216, low-income housing tax credit (LIHTC) programs 218 that are typically state-based, and blended programs 220 that may combine elements of HUD programs 216 and LIHTC programs 218. Programs 214 typically have various rules and guidelines to ensure that residents/applicants 202 are eligible and in compliance with all requirements of the housing program. Each housing program 214 typically has its own set of questionnaires 222 and forms 224 that must be completed for a resident/applicant 202 to qualify. Questionnaires 222 and forms 224 may include numerous and difficult questions that resident/applicant 202 may not fully understand, leading to substantial time being spent (frequently in person) between resident/applicant 202, property management 204, in answering such questions. Other supporting documents such as personal identification, proof of citizenship, bank statements, pay stubs, and other evidence of income and assets, court documents, and other criteria may also be required.

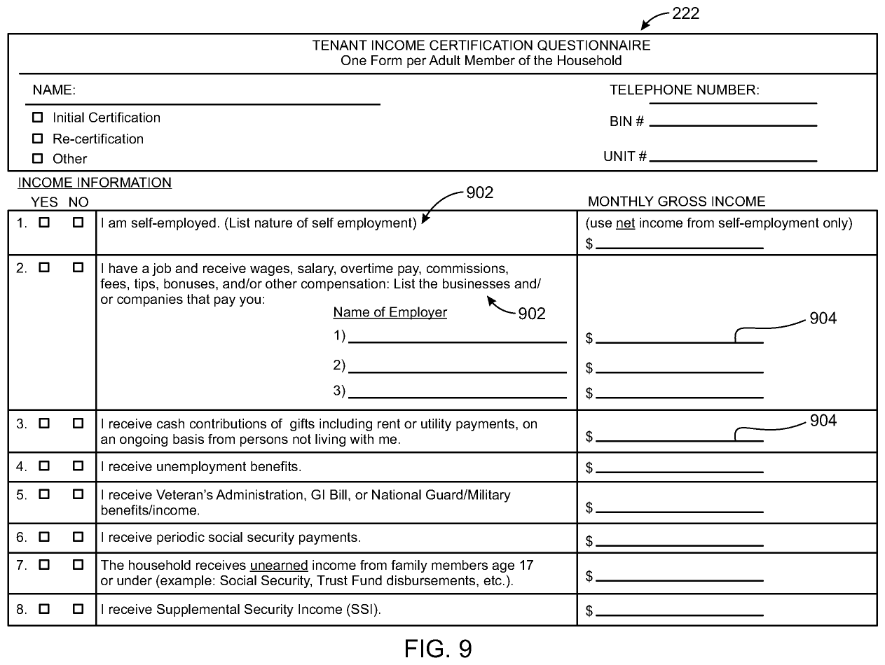

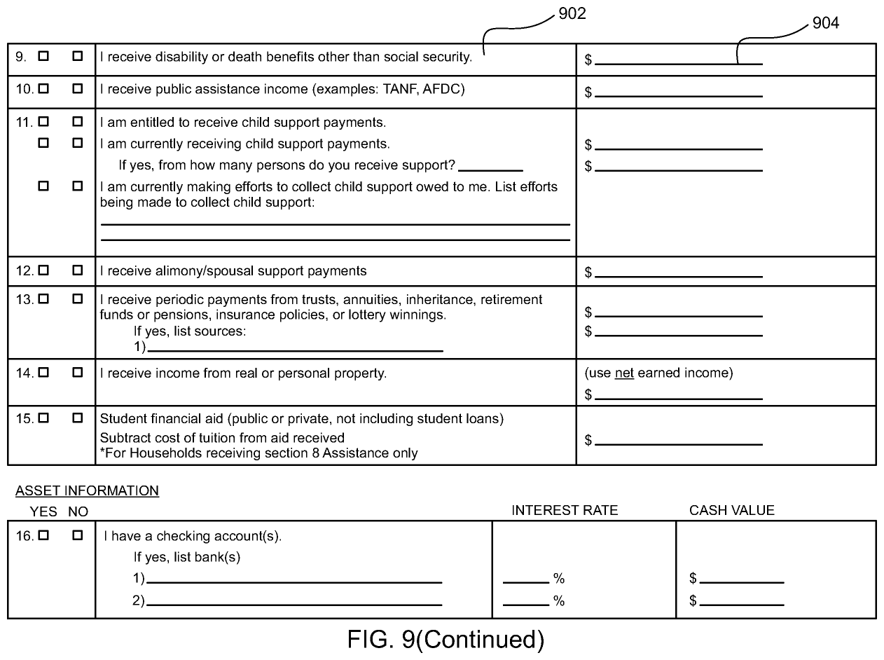

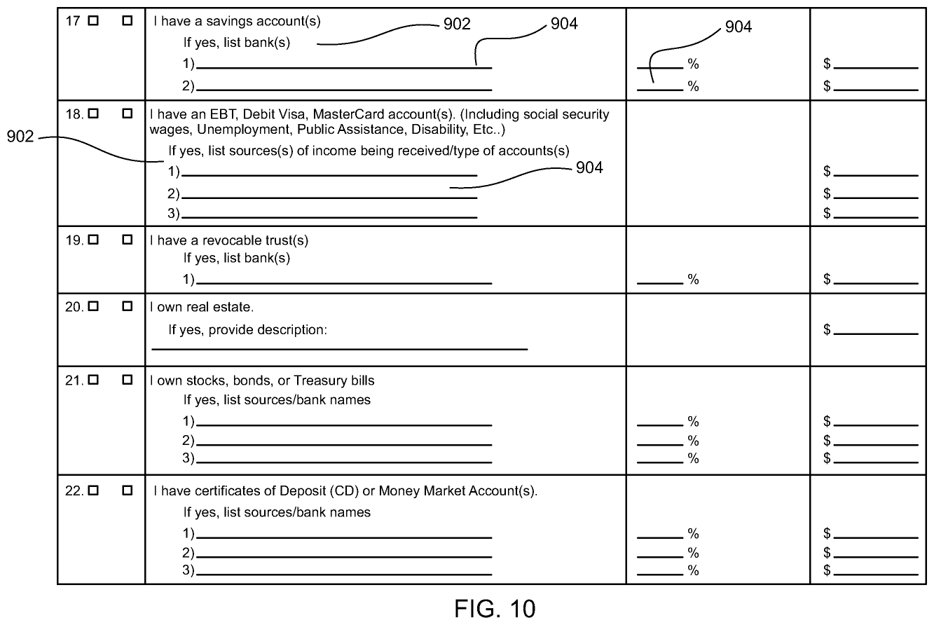

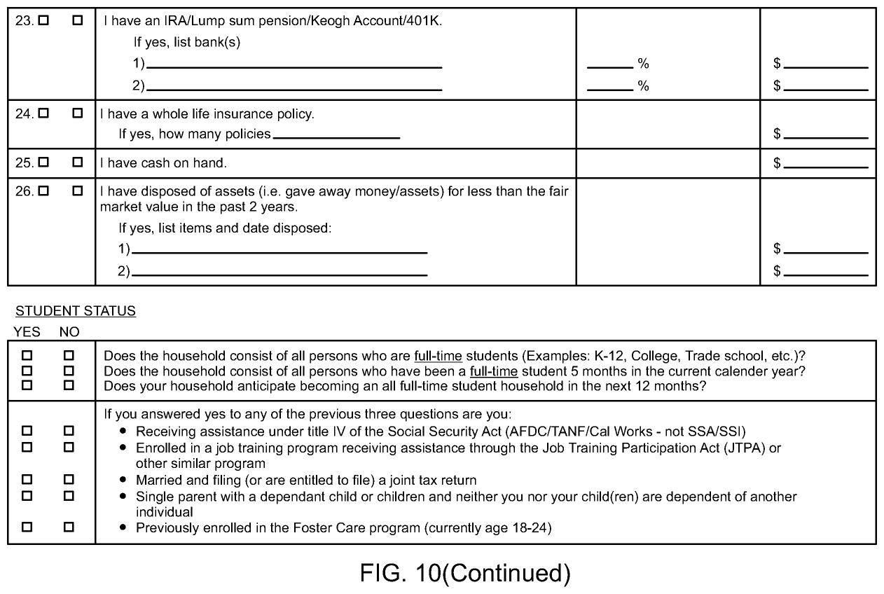

FIGS. 9 and 10 show an example of a questionnaire 222 that must be completed for a typical affordable/low-income housing program 214. Questionnaire 222 includes multiple questions 902 that must be completed as part of a typical certification process 208. FIGS. 9 and 10 depict a “Section 8/236-LIHTC Combo” questionnaire 222 containing questions 902 and fillable spaces/fields 904 that are typical of many housing programs 214. Questionnaire 222 of FIGS. 9 and 10, for example, is 47 pages long and must be completed for each certification 208. Questionnaire 222 includes extensive questions about asset and income information, student and family status, and more, requiring applicant/resident 202 or other individual filling out questionnaire 222 to have a thorough understanding of these matters. Questionnaire 222 includes multiple forms that applicant/resident 202 and other members of the household (anyone over 18) must sign, meaning that multiple parties often must provide signatures in order to complete certification 208. Advantageously, affordable housing application 128 is a computer-implemented system and application that allows the many individuals who play a role in certification process 208 to ensure, in a remote manner using computing device 101, that questionnaires 222, forms 224, and other required documents are correctly completed, signed, and stored for auditing or examination by a program representative/agent 236.

Certification 208 is the process of ensuring asset verification 230, income verification 232, and eligibility/status 234 checks for any resident/applicant 202 seeking to qualify for an affordable/low-income housing program 214. As noted above, certification 208 includes an initial or move-in certification 238 when an applicant/resident 202 initially moves into a housing facility or unit of housing program 214, which is typically the first certification process that occurs when a resident/applicant 202 moves into a specific facility. Certification 208 further entails annual certification 240 in which resident/applicant 202 must complete the same or updated questionnaires 222 and forms 224 and again provide all required supporting documents. HUD programs 216 also require that resident/applicant 202 recertify whenever there is any income change or an income change over a threshold amount. Resident/applicant 202 must correctly complete all questionnaires 222, forms 224 and provide all necessary supporting documentation.

Once all questionnaires 222, forms 224, and required supporting documents have been completed and provided, a completed certification 208 may be provided to program representative/agent 236 and may be stored for future reference and audits by administrators associated with housing program 214. In some embodiments, completed certifications 208 are stored with property management 204, which is typically audited at least once a year by administrators of housing program 214. Resident/applicant 202 may also keep and store a copy of the completed certification 208.

It is often difficult for resident/applicant 202 to fully understand all guidelines and requirements required for the certification process 208 of various housing programs 214, leading resident/applicants 202 to turn to property management 204 or compliance specialist 206 for help in filling out questionnaires 222 and forms 224. Further, resident/applicant 202, property management 204, and compliance specialist 206 must usually meet in person multiple times to complete questionnaires 222 and forms 224. There are also many specific deadlines and dates that must be met during certification process 208.

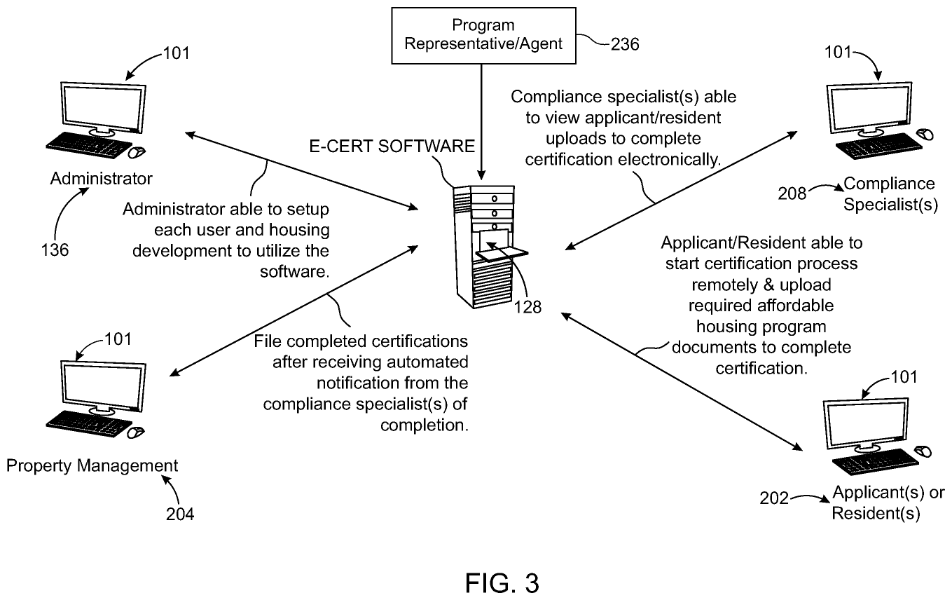

Advantageously, affordable housing application 128 allows resident/applicant 202 to remotely provide all necessary information for any certification 208 through a computing device 101. In this regard, the terms “remote certification” and “electronic certification” are used interchangeably herein. Property management 204 and compliance specialist 206 may also beneficially access affordable housing application 128 and enter or edit any necessary information. Further, and as explained with respect to FIGS. 3-19, affordable housing application 128 is configured to provide detailed answers and explanations in connection with questionnaires 222, forms 224, or other items required to complete certification 208. Affordable housing application 128 may provide tutorials and help related articles to assist resident/applicant 202, property management 204, and compliance specialist 206 when responding to any due dates, deadlines, or answering any questions in affordable housing application 128.

In some embodiments, affordable housing application 128 is a software program or service that maps obtained information and answers from the resident/applicant 202, property management 204, and compliance specialist 206 into corresponding fields and questions in questionnaires 222 or forms 224. For example, affordable housing application 128 may prompt resident/applicant 202 to provide answers to questions that provide answers for questionnaire 222 as shown in FIG. 9. Affordable housing application 128 may extract answers provided by resident/applicant 202 and map the answers to fillable fields and entries of questionnaires 222 and any forms 224 needed to comply with certification process 208.

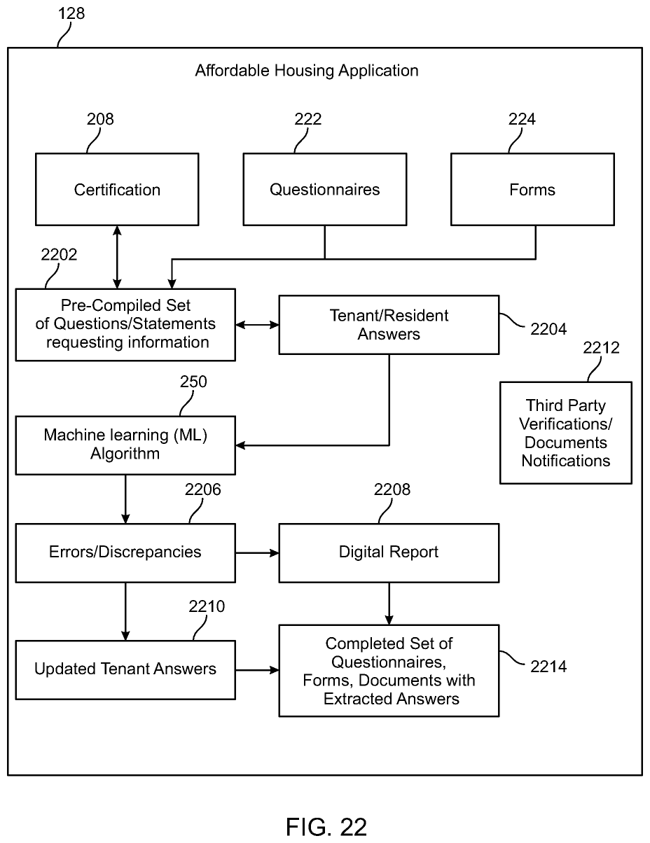

In some embodiments, affordable housing application 128 includes machine learning (ML) algorithm 250 that is trained to make instant eligibility decisions, provide guidance to the user through certification process 208, detect errors or discrepancies 2206, and many other functions, as is further explained with respect to FIGS. 22-24 below. In this description, once machine learning algorithm 250 has been trained on training data and is deployed in affordable housing application 128, it is referred to as artificial intelligence (AI) model 250.

FIG. 3 shows how various parties such as resident/applicant 202, property management 204, administrator 136, and compliance specialist 206 may use affordable housing application 128. Resident/applicant 202 may start certification process 208 remotely via affordable housing application 128 and upload any required documents to application 128. In some embodiments, administrator 136 sets up each user and housing development (e.g., each property belonging to property management 204) to use housing application 128. Property management 204 can view document uploads provided by resident/applicant 202 to complete certification 208 electronically. Property management 204 may complete certifications 208, for example, after receiving automated notifications of completion from compliance specialist 206. Compliance specialist 206 may view uploads of resident/applicant 202 to electronically complete certification process 208. In this manner, as shown in FIG. 3, any of parties 202, 204, 206, 136 may use its own computing device 101 to access affordable housing application 128.

FIG. 4 illustrates exemplary features of an interface for resident/applicant 202 that affordable housing application 128 provides on computing device 101. LOGIN tab 402 allows resident/applicant 202 to login to their profile or account. NOTIFICATIONS tab 404 provides information regarding certifications 208 available to complete, including information about the kind of information and documents needed, pending documents available for review, and attempts to reach resident/applicant 202. REPORT CHANGE tab 406 allows applicant/resident 202 to report household changes since initial certification process 208. E-CERT AVAILABLE tab 408 displays currently available certifications 208. E-CERT STATUS tab 410 displays status updates for each step in certification process 208, including pending verifications, signatures needed, and completed certifications 208. E-CERT HISTORY tab 412 stores completed electronic certifications 208 for future reference. In this regard, one advantage of housing application 128 is its ability to serve as a central repository and storage for completed questionnaires 222, forms 224, and certifications 208. MESSAGE/CALL US tab 414 allows a message or call to compliance specialist 206 for certification assistance. In some embodiments, resident/applicant 202 may also request assistance from administrator 136 or property management 204. Advantageously, resident/applicant 202 can remotely and electronically complete any action shown in FIG. 4 on their computing device 101, and can thereby avoid cumbersome and long trips to an office or other location and risks posed by airborne viruses such as COVID-19.

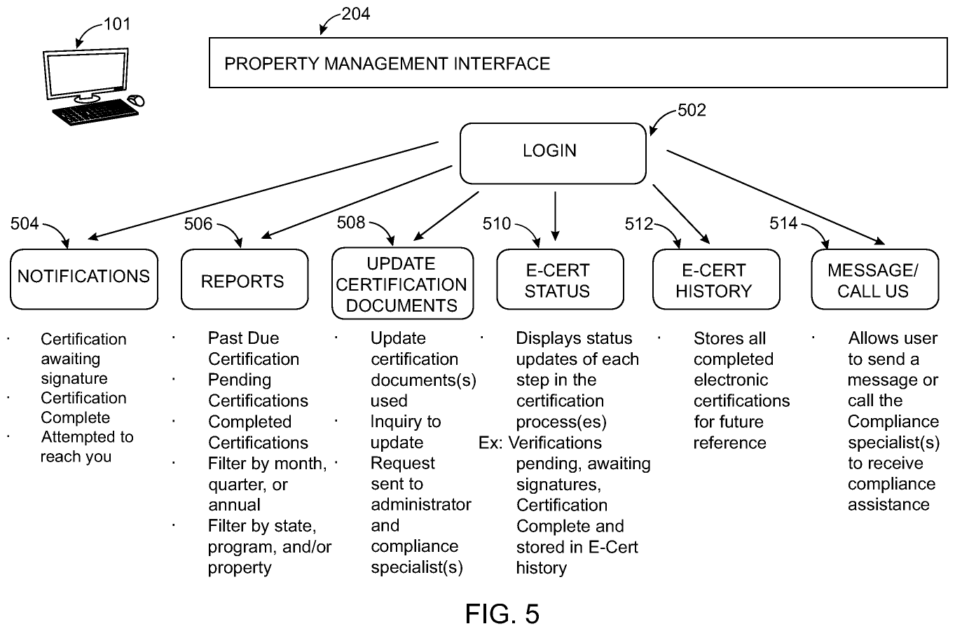

FIG. 5 illustrates exemplary features of an interface for property management 204 that affordable housing application 128 provides on computing device 101. LOGIN tab 502 allows property management 204 to login to their profile or account. NOTIFICATIONS tab 504 provides information regarding certifications 208 awaiting signature, completed certifications 208, and attempts to reach property management 204. REPORTS tab 506 provides reports about past due, pending, and completed certifications 208 that may be filtered, for example, by month, quarter, or year, and by state, program, or property. UPDATE CERTIFICATION DOCUMENTS tab 508 allows property management 204 to update certification documents, respond to inquiries to update certifications, and send requests to administrator 136 and compliance specialist 206 for assistance and other services. E-CERT STATUS tab 510 displays status updates for each step in certification process 208, which may include pending verifications, needed signatures, and completed certifications 208. E-CERT HISTORY tab 512 stores completed certifications 208 for future reference. Advantageously, the ability to access all completed certifications 208 electronically provides peace of mind and reassurance to property management 204 that all information about completed certifications 208 may be located using affordable housing application 128. MESSAGE/CALL US tab 514 allows a message or call to compliance specialist 206, administrator 136, or another party.

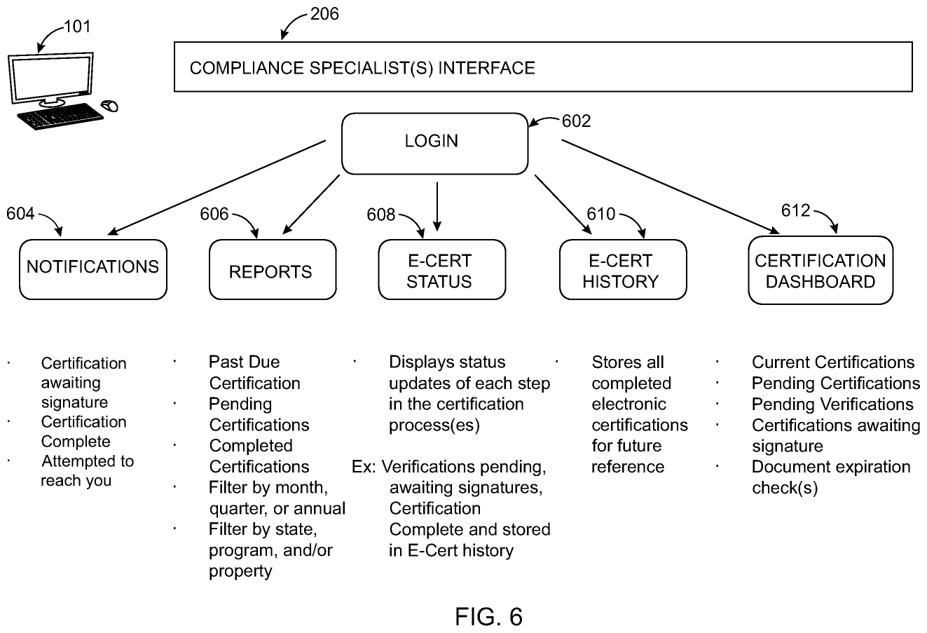

FIG. 6 illustrates exemplary features of an interface for compliance specialist 206 that affordable housing application 128 provides on computing device 101. LOGIN tab 602 allows compliance specialist 206 to login to their profile or account. NOTIFICATIONS tab 604 provides information regarding certifications 208 awaiting signature, completed certifications 208, and attempts to reach compliance specialist 206. REPORTS tab 606 provides reports about past due, pending, and completed certifications 208 that may be filtered, for example, by month, quarter, or year, and by state, program, or property. E-CERT STATUS tab 610 displays status updates for each step in certification process 208, which may include pending verifications, needed signatures, and completed certifications 208. E-CERT HISTORY tab 612 stores completed certifications 208 for future reference. CERTIFICATION DASHBOARD tab 612 provides access to current and pending certifications 208, pending verifications, certifications awaiting signatures, and document expiration checks. Accordingly, affordable housing application 128 serves to house all necessary certifications 208 and remind compliance specialist 206 of anything still needed, such as signatures, verifications, and documents.

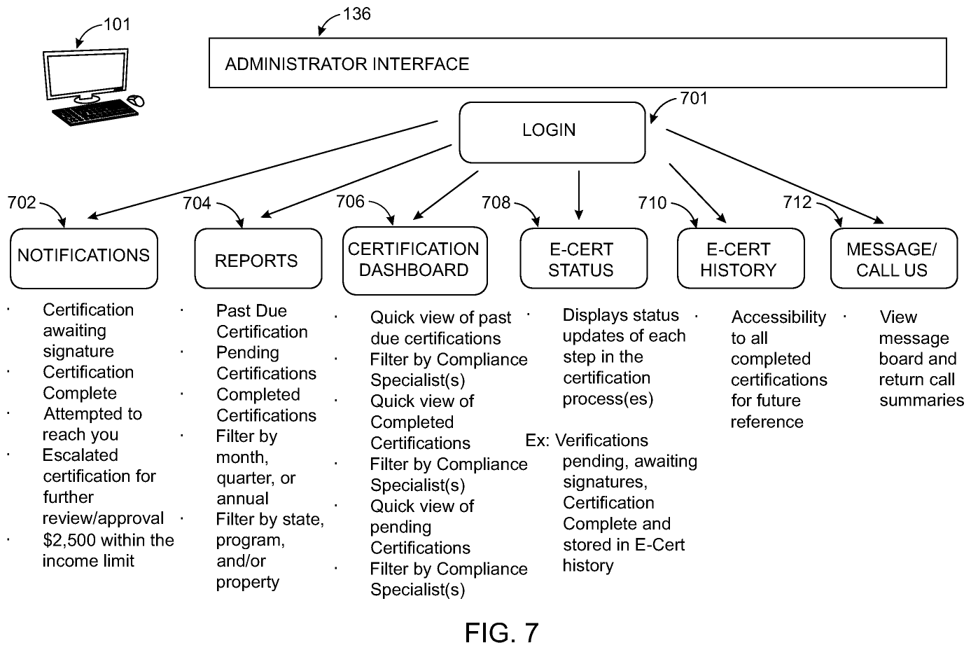

FIG. 7 illustrates exemplary features of an interface for administrator 136 that affordable housing application 128 provides on computing device 101. LOGIN tab 701 allows administrator 136 to login to their profile or account. NOTIFICATIONS tab 702 provides information regarding certifications 208 awaiting signature, completed certifications 208, and attempts to reach administrator 136. Notifications 702 may also relate to escalated certifications for further review/approval by administrator 136. REPORTS tab 704 provides reports about past due, pending, and completed certifications 208 that may be filtered, for example, by month, quarter, or year, and by state, program, or property. CERTIFICATION DASHBOARD tab 706 provides a quick view of past due, pending, and completed certifications 208 that may be filtered by compliance specialist. E-CERT STATUS tab 708 displays status updates for each step in certification process 208, which may include pending verifications, needed signatures, and completed certifications 208. E-CERT HISTORY tab 710 stores completed certifications 208 for future reference. MESSAGE/CALL US tab 712 allows administrator 136 to view message boards and return call summaries.

Thus, affordable housing application 128 is a one-stop location for all needs of resident/applicant 202, property management 204, compliance specialist 206, administrator 136, and any other party associated with housing program 214. In addition to the features described above, affordable housing application 128 may send reminders of pending deadlines and past due dates to parties using housing application 128 such as resident/applicant 202, property management 204, compliance specialist 206, and administrator 136.

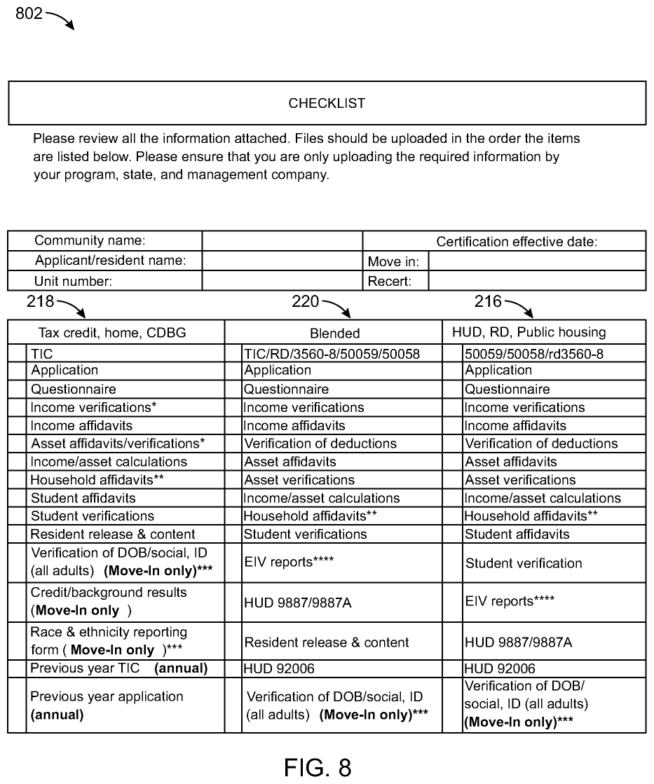

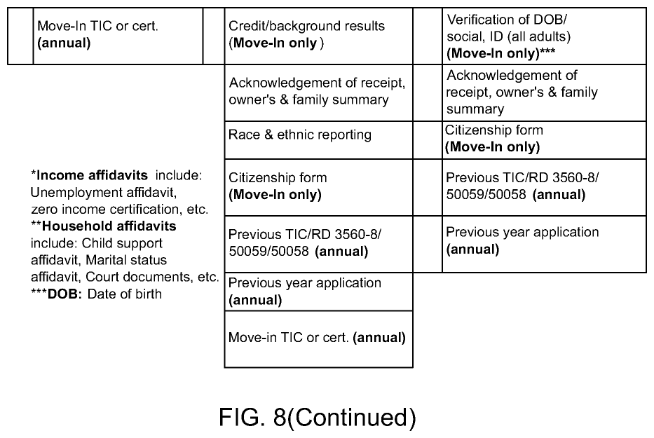

FIG. 8 depicts an exemplary checklist 802 that may be used by compliance specialist 206 to track of all necessary documents, questionnaires 222, and forms 224 needed to comply with current guidelines for HUD program 216, LIHTC program 218, and blended program 220. As can be seen in FIG. 8, there are many documents and items required for each program, and compiling these documents for multiple residents/applicants 202 and property management 204 may be very time consuming and difficult. Affordable housing application 128 offers multiple advantages and benefits over these existing methods of completing certifications 208.

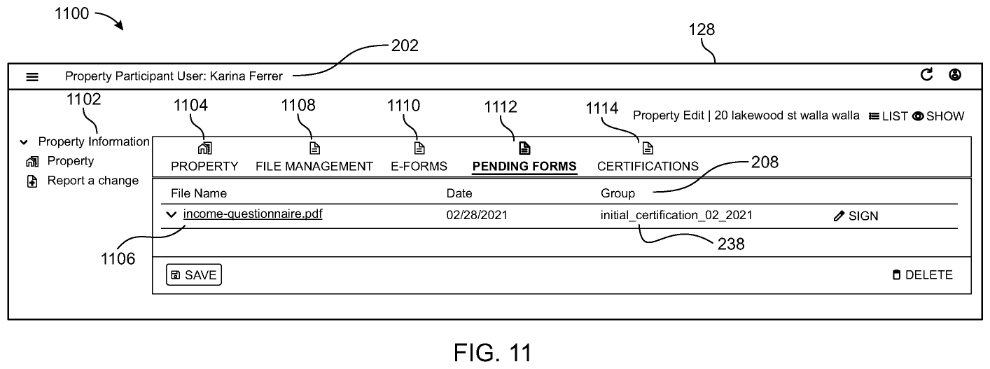

FIG. 11 shows an exemplary interface 1100 of affordable housing program 128 that allows resident/applicant 202 to remotely access questionnaires 222, forms 224, and other documents required for certification(s) 208 needed to participate in housing program 214. Interface 1100 includes relevant information 1102 about resident/applicant 202 such as address and property location, and various selectable icons including property icon 1104, file management icon 1108, e-forms (electronic forms) icon 1110, pending forms icon 1112, and certifications icon 1114. Icons 1104-1114 may be selected to view relevant information and documents associated with any type of certification 208 for resident/applicant 202. Property management 204, compliance specialist 206, and administrator 136 may also remotely access interface 1100 using their own computing device 101 to view what resident/applicant 202 can access and to assist in completion of questionnaires 222 and forms 224.

Income questionnaire 1106 under pending forms icon 1112 includes questions about income for resident/applicant 202. Tenant income certification questionnaire 222 of FIGS. 9-10, which is an actual questionnaire required by a government funded housing program 214, is one example of such an income questionnaire 1106. Questionnaire 222 of FIG. 10 (as represented by income questionnaire 1106 of FIG. 11) includes many pages of complex questions related to household income, assets, and other relevant factors used to determine eligibility for the lower cost benefits offered as part of housing program 214.

Income questionnaire 1106 is available on affordable housing application 128 for resident/applicant 202 to view, complete, and sign as needed. Interface 1100 shows that questionnaire 1106 is for an initial certification 238, which is needed because resident/applicant 202 is moving into a property participating in housing program 214 that requires initial certification 238 to be completed and stored for future auditing by a program representative/agent 236. Any party with access to the profile of resident/applicant 202 as shown in interface 100, including but not limited to resident/applicant 202, property management 204, compliance specialist 206, and administrator 136, may view and edit income questionnaire 1106 and its status as a pending form to be completed and signed. Resident/applicant 202 may remotely access affordable housing application 128 via network 142 and use input devices 106 of computing device 101 to answer any questions, fields, or other entries in income questionnaire 1106. In some embodiments, affordable housing application 128 may pose specific questions organized and prepared in advance (e.g., by administrator 136 or compliance specialist 206 or another party) that track the questions, fields, or other entries needed in income questionnaire 1106. Another interface of affordable housing application 128 may post these questions to resident/applicant 202. Any answers provided by resident/applicant 202 may be extracted and mapped to specific questions, fields, and entries of questionnaire 1106, and affordable housing application 128 may populate the data needed for questionnaire 1106 by extracting answers from resident/applicant 202 and mapping the answers to questionnaire 1106. Further, affordable housing application 128 may include selectable explanatory boxes or interfaces to provide help and guidance in understanding any question, field, or entry of form 224 or questionnaire 222.

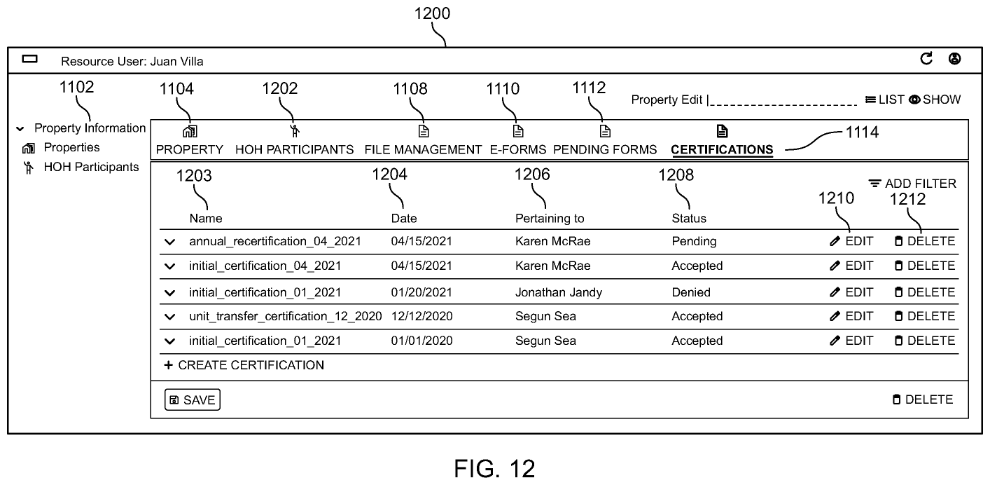

FIGS. 12-19 depict additional exemplary interfaces 1200-1900 of affordable housing application 128 that provide various types of information, including questionnaires 222, forms 224, and other documents that are either completed or need to be completed for a pending or completed certification 208. Interfaces 1200-1900 facilitate remote completion and signing of certifications 208 by resident/applicant 202 via network 142 and computing device 101. The information presented may be organized and displayed in various ways to best suit the needs of property management 204, compliance specialist 206, or another party. Each participant in affordable/low-income housing program 214 must be vigilant about assembling and completing all needed questionnaires 222, forms 224, and other supporting documents (e.g., proof of income, household, student status, etc.) such that certifications 208 are available for auditing by program representatives 236 who may visit the property at any time to confirm that property management 204 is verifying that resident/applicant 202 is eligible to begin or continue participation in housing program 214. If property management 204 is not vigilant in monitoring certifications 208 for each resident/applicant 202, it may be fined by the government or non-government agency enforcing housing program 214.

Interface 1200 of FIG. 12 may include property icon 1104, file management icon 1108, e-forms icon 1110, pending forms icon 1112, and certifications icon 1114 as described above with respect to FIG. 11. Further, there may be an additional icon 1202 for hard of hearing (HOH) participants who may have their own regulations and information required for submission of a certification 208. As shown under certifications icon 1114 of FIG. 12, the name 1203 of each pending, accepted, or denied certification is displayed and may include initial certifications 238, annual certifications 240, interim certifications 242, transfer certifications 244, and move out certifications 246. Interface 1200 displays other information including the date 1204 of the certification, the participant 1206, and status updates 1208 that indicate whether the associated certification is accepted, denied, or still pending approval. Further, the various elements of interface 1200 can be edited 1210 and deleted 1212 as needed.

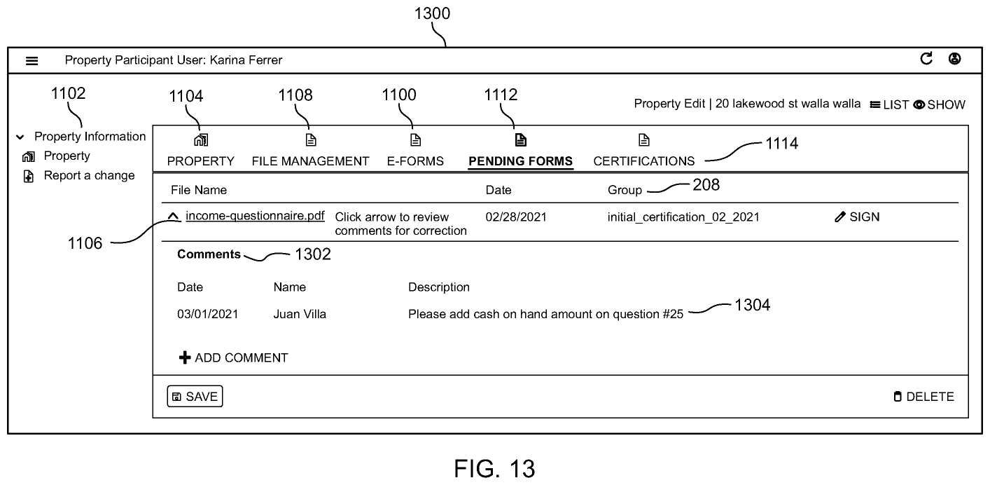

Interface 1300 of FIG. 13 shows that a reviewing party such as property management 204, compliance specialist 206, or administrator 136 may direct comments 1302 (including questions and requests for clarification) to resident/applicant 202 or another party. Comments 1302 may relate to items that resident/applicant 202 needs to answer, correct, add to, or update. For example, comment 1302 of FIG. 13 includes a description 1304 requesting that resident/applicant 202 provide “cash on hand amount answer to question #25” in income questionnaire 1106. The interfaces of affordable housing application 128 may request information or clarification from resident/applicant 202 in various ways. An alert or notification may be provided to resident/applicant 202 (such as by email or phone) when a comment 1302 is made in affordable housing application 128.

A reviewing party, such as property management 204, compliance specialist 206, or administrator 136, reviews or audits the responses of a resident/applicant 202 to questionnaires 222, forms 224, and other documents for accuracy. Affordable housing application 128 may include an error checking analyzer that checks for errors and discrepancies in completed questionnaires 222, forms 224, and other documents. In some embodiments, affordable housing application 128 includes AI model (trained ML algorithm) 250 that implements the error checking analyzer function and detects any errors and discrepancies. Thus, via interfaces such as interface 1300, affordable housing application 128 facilitates a remote certification process 208 between multiple users and ensures the accuracy and correctness of supplied information before approving a completed certification 208 for future review and auditing by a program representative/agent 236 of housing program 214.

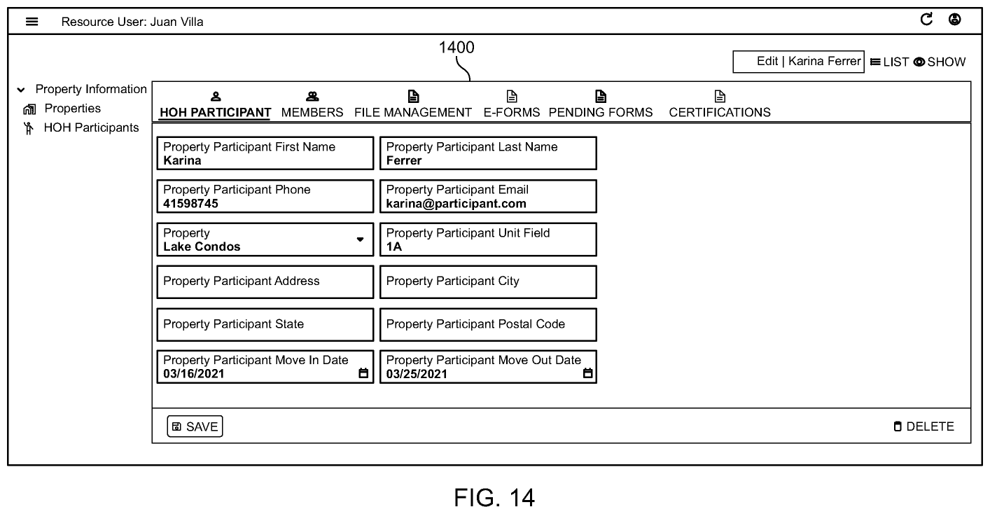

FIG. 14 shows exemplary interface 1400 of affordable housing program 128 in which relevant information about resident/applicants 202 is organized and displayed in an easy to view manner. As shown in interface 1400, the name, phone, email, apartment or field unit, address and location information, move-in and expected move out date are displayed for each resident/applicant 202. Interface 1400 is of great use and benefit to property management 204 of a property participating in affordable/low-income housing program 214 with one or more resident/applicants 202.

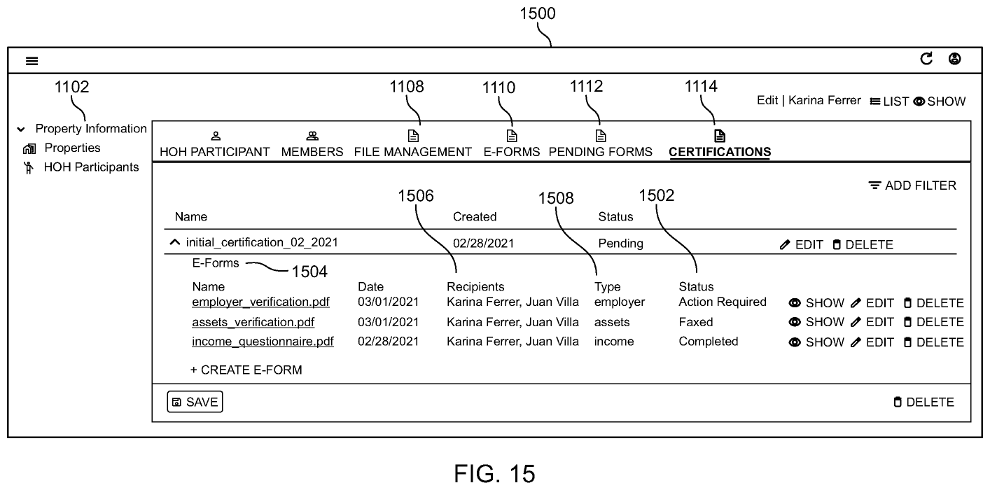

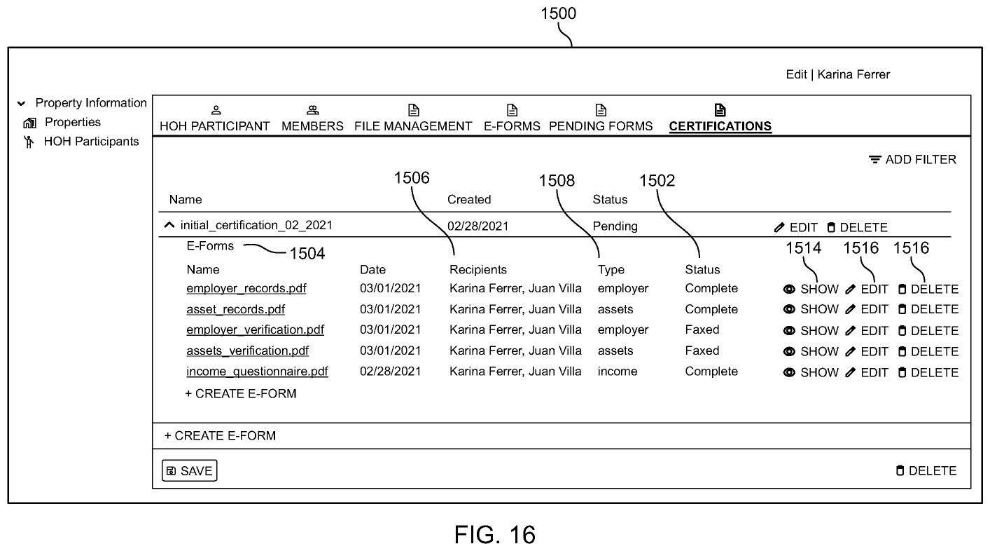

FIGS. 15 and 16 depict an exemplary interface 1500 including column 1502 that displays the status of various e-forms in column 1504 required for certification of a resident/applicant 202. Statuses indicated in column 1502 may include “action required”, “faxed”, “completed”, and any other appropriate status designation. E-forms in column 1504 may include, for example, employer verification documents, assets verification documents, income questionnaires, employer and asset records. Column 1506 lists the recipients of e-forms 1504 and may include any party 202, 204, 206, and 136. Column 1508 indicates the document type (e.g., employer, assets, income). All e-forms 1504 and their meta data can be displayed (1514), edited (1516), and deleted (1516) as needed in interface 1500.

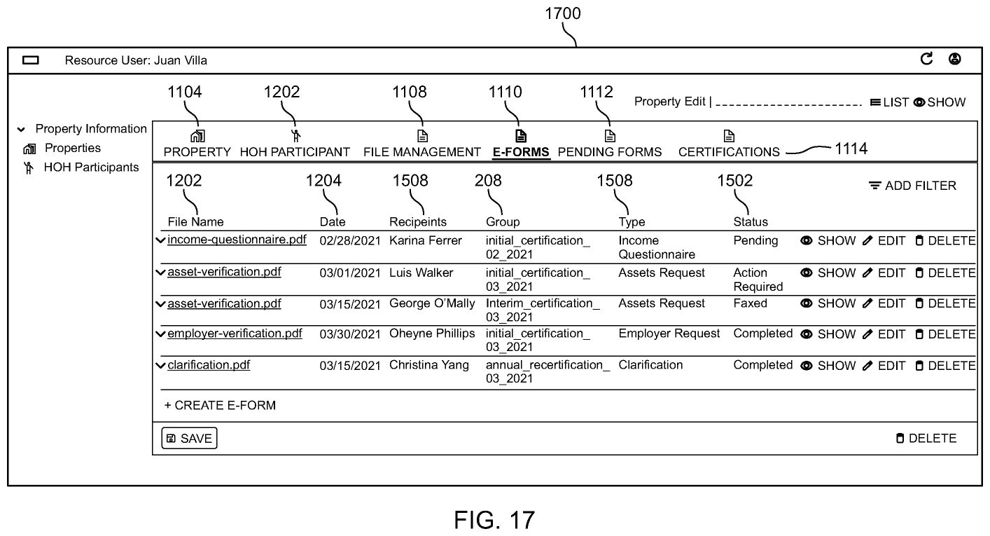

FIGS. 17-19 depict respective interfaces 1700, 1800, and 1900 that include the name 1203 and type 1508 of each form, questionnaire, or other document, as well as the date 1204 the document was created or last accessed. Interfaces 1700-1900 may categorize and organize these documents as they relate to a resident/applicant 202 or other party and according to their association with a particular type of certification 208 (e.g., initial certification 238, annual certification 240, interim certification 242, transfer certification 244, move out certification 246). Interfaces 1800 and 1900 display information related to pending and completed certifications 208. For example, interface 1900 organizes key features of each document including document type 1510, date 1904 that document was sent, information 1906 about document creation, information 1908 about document updates, and certification group type and status.

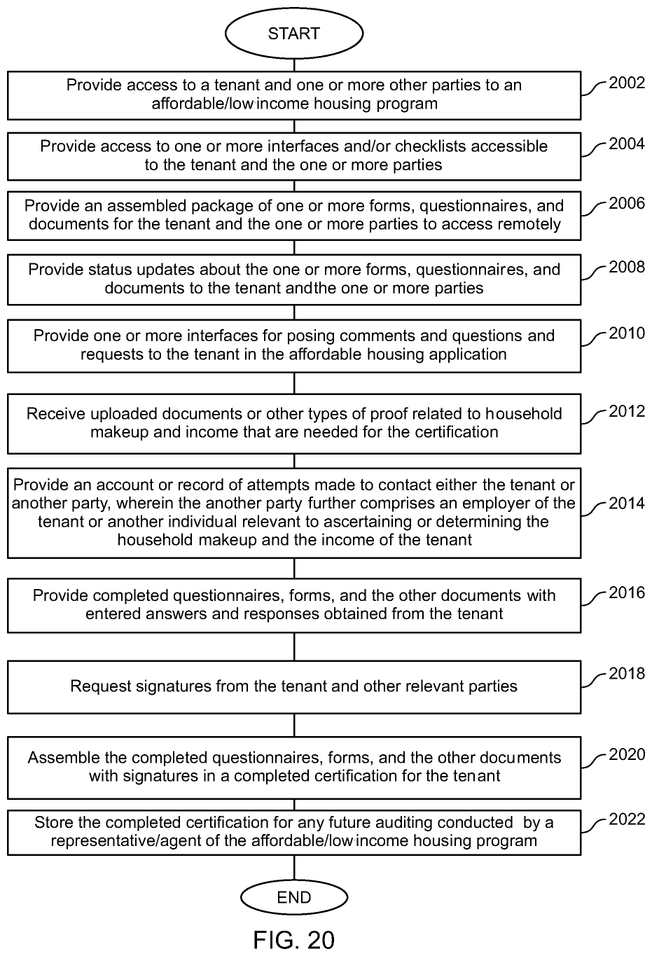

FIG. 20 is a flowchart of an exemplary method for using affordable housing application 128 according to some embodiments. Step 2002 provides resident/applicant 202 and one or more other parties (such as property management 204, compliance specialist 208, administrator 136, and program representative/agent 236) with access to affordable housing application 128 to complete any type of certification 208 required to participate in affordable/low-income housing program 214. Affordable housing application 128 may be remotely accessed over network 142 using computing device 101 to provide the information needed to complete certification 208. Step 2004 provides access to interfaces and checklists of items (such as checklist 802 of FIG. 8) needed to complete certification 208 to resident/applicant 202 and one or more other parties. The items in checklist 802 will depend on the particular housing program 214 and the type of certification needed (e.g., certifications 238-246 of FIG. 2). Step 2006 provides an assembled package of forms, questionnaires, and documents for resident/applicant 202 and one or more other parties to access and complete remotely. Step 2008 provides status updates (e.g., pending, complete, further action needed) about the questionnaires, forms, and documents to resident/applicant 202 and one or more other parties. Step 2010 provides an interface such as interface 1300 of FIG. 13 for posting comments 1302 (including questions and requests for clarification) to resident/applicant 202. Step 2012 receives uploaded documents or other types of proof related to household makeup and income that are needed for certification 208. Step 2014 provides an account or record of attempts made to contact resident/applicant 202 or another party such as an employer or other individuals relevant to ascertaining household makeup and income. Step 2016 provides completed questionnaires 222, forms 224, and other documents with answers and responses as entered by resident/applicant 202. Step 2018 requests signatures from resident/applicant 202 and other relevant parties. Step 2020 assembles the completed questionnaires 222, forms 224, and other documents with signatures in a completed certification 208. Step 2022 stores completed certification 208 for future auditing by a representative/agent 236 of housing program 214.

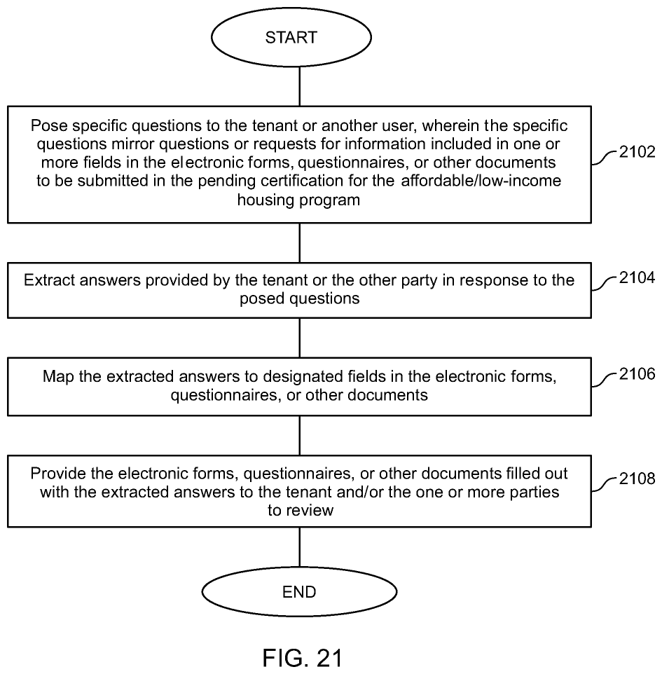

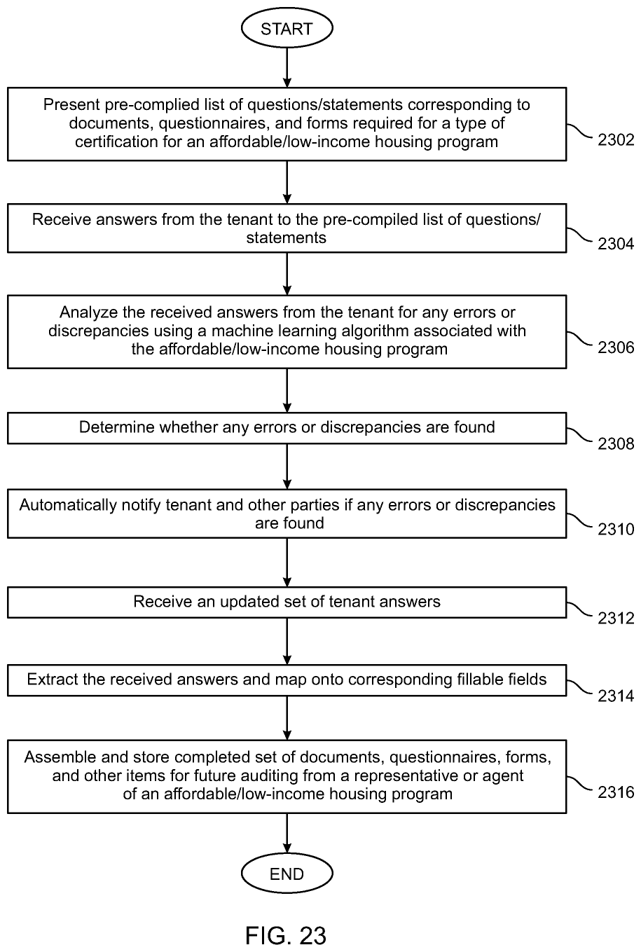

FIG. 21 is a flowchart of an additional exemplary method by which affordable housing application 128 may provide the required data and information in questionnaires 222, forms 224, and other documents. Step 2102 poses specific questions to resident/applicant 202 or another user that mirror questions or requests for information included in one or more fields in forms 224, questionnaires 222, and other documents to be submitted in pending certification 208 for housing program 214. In regard to step 2102, FIG. 9 shows an exemplary questionnaire 222 having questions 902 that may be mirrored and posed to resident/applicant 202 or another party. Step 2104 extracts the answers provided in response to the posed questions. Step 2106 maps the extracted answers to designated spaces or fields in forms 224, questionnaires 222, or other documents. Step 2108 provides forms 224, questionnaires 222, and other documents filled out with the extracted answers to resident/applicant 202 or another party for review. If edits to the extracted/mapped answers are needed, resident/applicant 202 or another party 204, 206, 136 may make such edits and sign the completed form 224 or questionnaire 222 using the interfaces in affordable housing application 128. Alternatively, if no edits are required, the tenant 202 or other appropriate party may sign the completed form 204 or questionnaire 222 using one or more interfaces in affordable housing application 128. Steps 2102-2108 of FIG. 21 may be performed in combination with other steps such as steps 2002-2022 of FIG. 20 and steps 2302-2316 of FIG. 23.

FIG. 22 is a block diagram of an exemplary process provided by affordable housing application 128 according to one or more non-limiting embodiments. In some embodiments, affordable housing application 128 includes AI model (trained ML algorithm) 250 that detects errors and discrepancies 2206 in answers 2204 provided by resident/applicant 202. As shown in FIG. 22, once it has been determined which type of certification 208 is required, resident/applicant 202 is provided with a pre-compiled set of questions/requests for information 2202 via one or more interfaces of affordable housing application 128. Pre-compiled set of questions 2202 presents in a clear, straightforward, and summarized manner a set of questions that relate and correspond to the questions or requests for information in questionnaires 222, forms 224, and other documents associated with certification 208. Questionnaires 222, forms 224, and other required documents may relate to an initial or move-in certification 238, an annual certification 240, an interim certification 242, a transfer certification 244, or a move out certification 246.

Pre-compiled set of questions 2202 may be prepared by one or more parties with knowledge of the documents and items required for certification 208, including, such as property management 204, compliance specialist 206, administrator 136, or another party. Pre-complied set of questions 2202 may comprise digital questions and requests for information that relate to questions or statements included in questionnaire 222, form 224 or other documents associated with housing program 214. As shown in FIGS. 9 and 10, for example, there are a series of questions 902 included on questionnaire 222 that must be answered accurately and completely, and that frequently lead to a requirement to provide further information. For example, a list of bank accounts may lead to a requirement that bank representatives verify those accounts. Pre-compiled set of questions 2202 may be based on questionnaires 222, forms 224, and other documents required for a specific type of certification 208, but pre-compiled set of questions 2202 are not necessarily presented in the same order or manner as shown on questionnaire 222 and forms 224. Rather, administrator 136 or compliance specialist 206 may organize pre-compiled set of questions 2202 in a different order and may pose questions 2202 in a different manner in an effort to clearly obtain consistent answers from resident/applicant 202.

Pre-compiled set of questions 2202 may be organized and assembled in a single or multiple interfaces of affordable housing application 128. Resident/applicant 202 may start, stop, and pause the process when providing answers 2204 to pre-compiled set of questions 2202, thus giving resident/applicant 202 the time and ability to collect information needed to respond to pre-compiled set of questions 2202. Accordingly, affordable housing application 128 may dedicate space in its memory and processing to automatically save partially completed pre-compiled set of questions 2202. It is noted that questionnaires 222 and forms 224 required by each type of certification 208 usually involve numerous and lengthy questions/statements for verification that take a great deal of time and attention from resident/applicant 202. Pre-compiled set of questions 2202 may be a simplified version of the same questions/statements from questionnaires 222 and forms 224, but as discussed above are not presented necessarily in the same order or manner as shown on questionnaire 222 and forms 224. Affordable housing application 128 may further include selectable and digitally presented explanations for the questions in pre-compiled set of questions 2202, such as pop-up windows and/or video tutorials with explanations and example answers.

In some embodiments, answers 2204 to pre-compiled set of questions 2202 are submitted for analysis to AI model 250, which is trained to detect errors and discrepancies 2206 in answers 2204. In one non-limiting embodiment, AI model 250 is a supervised ML algorithm trained by labelled input and output training data. Alternatively, AI model 250 may be an unsupervised ML algorithm trained by unlabeled or raw data. Input and training data for AI model 250 may be provided by administrator 136, compliance specialist 206, and property management 204. AI model 250 thus serves as a quality control module to ensure that answers 2204 are free from inconsistencies and errors/discrepancies 2206. AI model 250 may create digital report 2208 that lists and summarizes errors/discrepancies 2206 and can be viewed via interfaces of housing application 128. Digital report 2208 may also be sent via email, instant message, text, fax, or other means to one or more parties including resident/applicant 202, compliance specialist 206, and property management 204.

Once answers 2204 have been analyzed by AI model 250 for error and discrepancies 2206, second questions may be posed to the applicant that correspond to the fillable fields in the associated questionnaires, forms, or documents but in a different order or manner. An updated set of answers 2210 to the second questions is then assembled. Updated answers 2210 may be provided by resident/applicant 202, compliance specialist 206 and/or property management 204. Further, in some embodiments, AI model 250 may provide or assist in providing updated answers 2210. In some embodiments, affordable housing application 128 may assemble and organize updated answers 2210 into a completed set of questionnaires, forms, and documents 2214 with answers extracted from updated answers 2210. That is, affordable housing application 128 is configured to extract answers from updated answers 2210 and map the extracted answers to specific spaces/fillable fields 904 in questionnaires 222 and forms 224 (see FIGS. 9 and 10). The completed set of questionnaires, forms, and documents 2214 including affidavits and third party verifications is stored by affordable housing application 128 and is accessible to parties including resident/applicant 202, administrator 136, property management 204, compliance specialist 206, and program agent or representative 236.

In some embodiments, affordable housing application 128 scans and reviews answers 2204/2210 to determine whether any of answers 2204/2210 require third party verifications or documentation. Such third party verifications or documentation may be received from employers, financial institutions, legal agents or representatives, or any other party that can provide corroborating information or documentation regarding assets, employers, household, and student verifications for resident/applicant 202. In some embodiments, AI model 250 may automatically notify any third party (via notifications 2212) that needs to provide third party verifications and documentation. In some embodiments, a database accessible by affordable housing application 128 may include emails, fax numbers, etc. for contacts associated with third parties needed for verification and documentation. If third party verification or documentation is required, affordable housing application 128 may send notifications 2212 (FIG. 22) to those third parties. In one embodiment, affordable housing application 128 is configured to send third party notifications 2212 via email, fax, text, or instant message. Automatic third party notification is advantageous as obtaining third party verifications and documentation is often a time-consuming and difficult process.

Affordable housing application 128 may also automatically initiate a certification process 208 to verify continued eligibility of resident/applicant 202 upon receiving a notification of household changes. In some examples, AI model 250 analyzes such household changes and if appropriate automatically initiates certification process 208. Such household changes may relate to changes in the number of people in the household, changes in income or financial status, changes in marital status, and changes in employment as entered by resident/applicant 202 into affordable housing application 128. Affordable housing application 128 may also automatically notify resident/applicant 202 or another party to submit any affidavits needed for the type of certification 208, such as affidavits affirming income, assets, student status or information, credit, race, ethnicity, or household makeup of resident/applicant 202.

FIG. 23 is a flowchart of an exemplary method provided by affordable housing application 128. Step 2302 presents a pre-compiled list of questions 2202 corresponding to questionnaires 222, forms 224, and other documents required for a type of certification for a housing program 214. Step 2304 receives answers 2204 to pre-compiled list of questions 2202. AI model 250 then analyzes answers 2204 for errors or discrepancies 2206 in step 2306. Step 2308 determines whether any errors or discrepancies 2206 were detected by AI model 250. As described above, a digital report 2208 may be produced listing any errors/discrepancies 2206 or other issues such as third party verifications and documentation that is needed.

Step 2310 automatically notifies resident/applicant 202 and other parties if any errors or discrepancies 2206 are found. Once answers 2204 have been analyzed by AI model 250 for error and discrepancies 2206, second questions may be posed to the applicant that correspond to the fillable fields in the associated questionnaires, forms, or documents but in a different order or manner. An updated set of answers 2210 to the second questions is then assembled. Updated answers 2210 may be supplied by resident/applicant 202, property management 204, compliance specialist 206, or another party. In some embodiments, AI model 250 provides or assists in providing updated answers 2210. Updated answers 2210 are then extracted and mapped in step 2314 into corresponding fillable fields 904 in questionnaires 222, forms 224, and other documents associated with certification 208. Questionnaires 222 and forms 224 are usually quite lengthy and must typically be filled out by hand by resident/applicant 202 or by compliance specialist 206. Affordable housing application 128 is advantageously configured and trained to interpret answers 2204 and 2210 and map those answers to the correct fields 904 in questionnaires 222 or form 224, which makes the process smoother, easier, and more accurate for resident/applicant 202, property management 204, and compliance specialist 206. Step 2316 assembles and stores a completed set 2214 of questionnaires 222, forms 224, and other documents for future auditing from a representative or agent 236 of housing program 214.

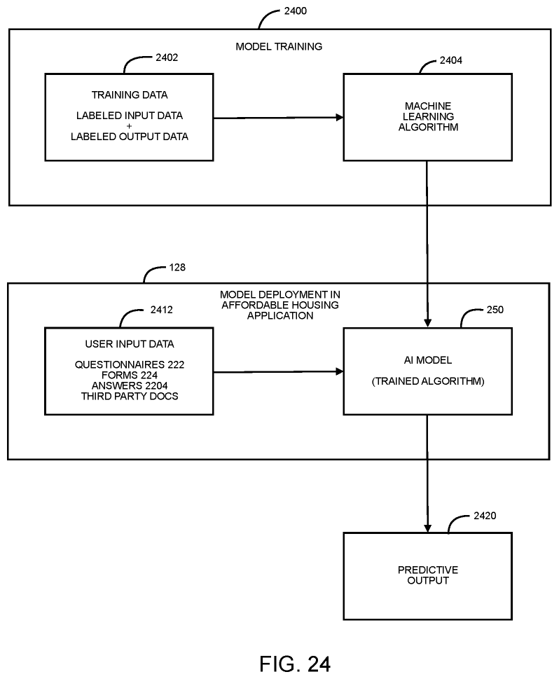

FIG. 24 is a block diagram that conceptually illustrates training and deployment of AI model (trained ML algorithm) 250 in affordable housing application 128. As described above, AI model 250 is trained to review submitted documents for accuracy (i.e., detect errors and discrepancies) and fraud detection. In some examples, AI model 250 is further trained on the exact standards and requirements for the applicable housing program 214 to produce instant eligibility and certification results, and to provide guidance to users.

Referring again to FIG. 24, before deployment of AI model 250 in affordable housing application 128, there is an AI model training phase 2400. In training phase 2400, training data 2402 is collected and is used to train a chosen ML algorithm(s) 2404. Training data 2402 may be extracted, for example, from previously completed and accurate questionnaires 222, forms 224, and other documents of resident/applicants 202, as well as from the standards and requirements for the housing program 214. In extracting training data 2402, optical character recognition (OCR) may be used to recognize and extract details and data such as text and numbers from scanned or imaged documents. Further, optical mark recognition (OMR) may be used to recognize and extract machine-readable marks such as checkboxes and bubble fills in forms. Natural language processing (NLP), which is a technique for analyzing and interpreting natural human language, may be applied to identify key fields in documents such as pay period dates, gross pay, deductions, beginning balances, ending balances, etc. Named entity recognition (NER), which is an NLP technique for identifying and extracting entities such as names, locations, etc. from text, may be used to detect identifiers such as employee name, employer name, etc. Once relevant training data 2402 has been extracted from questionnaires 222, forms 224, and other documents using some or all of these techniques, the extracted data may be validated by comparing it with expected formats and ranges.

Before being used to train ML algorithm 2404, the raw training data 2402 is processed to prepare it for analysis. This may include steps such as data cleaning to address inconsistencies and missing values, data standardization for uniformity, and encoding to transform the data into a format amenable to ML algorithms. In addition, in a supervised learning scenario, the input data and the output data may be labeled. Labeling input and output data in supervised learning involves assigning known values or categories to data to guide the ML algorithm in learning the relationship between inputs and outputs. For classification tasks, labels may be discrete categories (e.g., “eligible” or “not eligible”), whereas for regression tasks, labels may be continuous values (e.g., gross pay). The labeling process may be manual, with human annotators assigning labels based on predefined criteria, automated through rule-based systems or pre-trained models, or a mix such as semi-supervised learning where a smaller labeled dataset helps to label the rest.

Next, a suitable ML algorithm is chosen (block 2404) and trained on training data 2402. In training ML algorithm 2404 for deployment in affordable housing application 128, the focus is on accuracy and the ability to process and analyze a wide range of document types and data formats. Where the input and output training data is labeled, ML algorithm 2404 may employ supervised learning techniques, with algorithms such as neural networks to analyze sequential data such as paystubs for predicting future income. One non-limiting example of a suitable neural network is a recurrent neural network (RNN) with long short-term-memory (LSTM) cells. RNNs with LSTM can detect anomalies in sequential data by learning the usual patterns in a time series of data, and thus may be useful in identifying and handling anomalies such as missing pay stubs, job changes, outliers, etc. Any other suitable supervised learning algorithm may alternatively be used such as, without limitation, decision trees and support vector machines.

For locating specific fields on a template, such as paystubs, bank statements, quarterly investment statements, etc. and extracting specific information from the text of such documents, a custom natural language processing (NLP) model may be used. An NLP or other suitable ML algorithm may also be useful for analyzing and classifying unstructured income documents such as bank statements, benefits letters, etc. ML algorithm 2404 may also train regression models to infer annual income based on pay frequencies (weekly/bi-weekly/semi-annual/etc.) and pay rates and to assess eligibility against housing program requirements. Inferred income can then be validated against acceptable income limit ranges. Regression models may also be trained to infer requirements for housing programs from monthly, quarterly, or annual assets and add to income if necessary. Rule-based logic may also be applied on top of extracted data to calculate averages and annualize amounts. The chosen ML algorithm 2402 should also be able to compare previously seen data from the same third party (employers, banks, etc.) to check for continuity and authenticity. Tasks such as identifying eligible/ineligible households for auditing and providing suggested income calculations for human review may also be performed by ML algorithm 2402, thereby supporting the housing application process with robust data analysis and verification capabilities.

Once training data 2402 is collected and processed for uniformity, and an ML algorithm 2404 is chosen, training phase 2400 begins, where ML algorithm 2404 learns from training data 2402 to create AI model (trained ML algorithm) 250. During training phase 2400, ML algorithm 2404 is exposed to training data 2402, which includes the input data and, for supervised learning, the corresponding target outputs. ML algorithm 2404 makes predictions based on the input data and is then corrected by a learning process that minimizes the difference between its predictions and the actual outcomes using a method such as gradient descent. This iterative process is conducted over many cycles until performance of ML algorithm 2404 on training data 2402 improves to a satisfactory level, effectively fine-tuning the parameters of AI model 250. For unsupervised learning tasks, ML algorithm 2404 identifies and learns the patterns and structures within training data 2402 without target outputs. The result is an AI model 250 that is capable of making informed predictions or decisions, recognizing complex patterns, and extracting insights from new, unseen data.

The product of training ML algorithm 2404 with training data 2402 is AI model (trained ML algorithm) 250, which is deployed in affordable housing application 128. AI model 250 generates predictive outputs 2420 based on new user input data 2412, which may include data extracted from questionnaires 222, forms 224, answers 2204/2210, and third party documents. In extracting user input data 2412 from these sources, OCR may be used to recognize and extract details and data such as text and numbers from scanned or imaged documents. Further, OMR may be used to recognize and extract machine-readable marks such as checkboxes and bubble fills in forms. NLP may be applied to identify key fields in documents such as pay period dates, gross pay, deductions, beginning balances, ending balances, etc. NER may be used to detect identifiers such as employee name, employer name, etc.

Once input data 2412 has been extracted using some or all of these techniques, it undergoes processing similar to that of training data 2402 to ensure that it matches the format and structure that AI model 250 expects. This may include normalization, encoding categorical variables, handling missing values, and potentially applying specific transformations that were used during training. Processed data 2412 is then fed into AI model (trained ML algorithm) 250, which applies its learned parameters and algorithms to analyze user input data 2412 and generate predictive output 2420. This may include, for example, identifying errors or inconsistencies in submitted documents or answers, assessing eligibility for a housing program 214, initiating a certification process 208, estimating values such as expected income, and many other housing program related functions. Output 2420 of AI model 250 is the predictive analysis or decision that model 250 has made based on the patterns and relationships it learned during training phase 2400. Output 2420 is then processed by affordable housing application 128, which may include transforming output 2420 into a human-interpretable form, generating digital report 2208, or other functions.

Some examples of specific functions that may be carried out by AI model 250 are now described in more detail. First, and importantly, AI model 250 may review submitted documents for errors, discrepancies, and validity, and to confirm that they meet the requirements of housing program 214. As described above, affordable housing application 128 receives various uploaded documents from resident/applicants 202 or other parties (FIG. 20; step 2012). AI model 250 meticulously reviews, analyzes, and scrutinizes documents submitted by resident/applicants 202 or other parties to detect any errors or inconsistencies and to ensure compliance with the standards of housing program 214. For example, AI model 250 may examine sequences of documents, such as pay stubs, to very their sequential order and uniqueness and to catch instances where the same document may have been uploaded multiple times in error. For example, if resident/applicant 202 is required to upload three consecutive pay stubs, AI model 250 will detect if the same pay stub has been erroneously uploaded more than once.

AI model 250 is trained on the exact standards and requirements of the applicable housing program 214 to produce guidance to users and instant eligibility and certification results. Once uploaded documents have been confirmed as authentic and meeting the requirements of housing program 214, and once input data 2412 has been extracted from the uploaded documents using techniques such as NLP, OCR, OMR, NER, and other pattern recognition techniques, AI model 250 may then automatically determine the eligibility or ineligibility of a household by applying the housing program standards and requirements to input data 2412. In some examples, AI model 250 may provide a full or partial alternative to the current requirement for manual document validation by humans.

AI model 250 may play a dual role of both verifier and advisor. In addition to authenticating and confirming the compliance of uploaded documents, and using the extracted data and responses to make eligibility and certification decisions, AI model 250 serves as an interactive guide, offering users guidance on any aspect of a particular housing program 214 or certification 208. For example, AI model 250 may offer explanations on housing-specific terminology, as well as on any updates and changes in the housing program 214. In this regard, AI model 250 is able to refer back to archived materials for longer-term existing residents 202. For example, if a user queries as to the meaning of housing program-specific terms or acronyms such as “AR”, “IR”, and “IC”, AI model 250 may reply with clarification that “AR is annual recertification, IR is interim recertification, and IC is initial recertification.” AI model 250 also enhances accessibility by offering translations of documents and questions into the user's preferred language.

AI model 250 also adeptly responds to inquiries about housing program changes and other procedural changes. In another example, if a user inquires as to why there has been an increase in the number of paystubs required for certification, AI model 250 may reference the exact date of the change and direct the user to appropriate resources for further information.

AI model 250 serves as an intelligent guide through the intricacies of housing programs 214, assisting users with its comprehensive understanding of program standards and requirements. AI model 250 provides immediate responses to queries regarding eligibility criteria such as minimum and maximum income thresholds, and keeps users informed about their application status, such as waitlist positions for properties. AI model 250 can walk users through the certification process 208 in an interactive manner with examples that clarify each step. As discussed above, during certification process 208, AI model 250 may analyze answers 2204 of resident/applicant 202, identify errors and discrepancies 2206 in answers 2204, and provide or assist in providing updated answers 2210. If a user skips a step or encounters difficulty, AI model 250 provides real-time reminders and inquires as to whether additional support is needed to complete the missed step.

As described above, AI model 250 may automatically notify third parties to provide any needed third party verifications and documentation. If the verification or documentation of the third party has not been provided, automated requests are sent to the third party for the verification or documentation. To prevent fraud, the AI model may flag discrepancies and initiate reviews, such as by conducting a one-on-one video conference meeting with the tenant.

AI model 250 provides resident/applicants 202 with real-time assistance and resources tailored to report household changes accurately. When a resident 202 is unsure about the necessity of reporting a change within their household, such as income variations or family composition shifts, AI model 250 offers guidance in alignment with the specific standards and requirements of housing program 214. In some examples, AI model 250 assesses the reported changes against program rules to determine if a new certification is warranted, and if appropriate automatically initiates certification process 208. AI model 250 may further proactively predict and advise on potential implications of any household changes, ensuring that residents 202 stay informed and compliant with program mandates. Thus, AI model 250 not only educates users but also facilitates streamlined and efficient management of their housing needs.

AI model 250 is equipped with dynamic updating capabilities to ensure it remains current with the latest housing program regulations and requirements. When there are changes to income thresholds that determine eligibility, for instance, AI model 250 can swiftly incorporate these changes into its decision-making framework. If a housing program 214 raises the maximum annual income limit for a 2-person household from $45,000 to $55,000, for example, AI model 250 automatically adjusts its parameters to reflect this new standard from the effective date. Thus, the guidance provided by AI model 250 to users, the eligibility determinations it makes, and the advice it offers on required documentation are always in accordance with the most recent program rules.

AI model 250 can significantly enhance the customer service experience by offering automated, instant responses to inquiries related to housing programs 214, certifications 208, and other matters, acting as a first point of contact for users seeking information. In addition to answering questions for resident/applicants 202 currently in the system, AI model 250 can also provide comprehensive support to individuals on waitlists, keeping them informed about their status and any program-related updates. AI model 250 could potentially take over the functions of a traditional call center, providing real-time solutions to a range of queries, from providing information about program details to resolving software issues. AI model 250 improves response times, ensures consistent and accurate information dissemination, and reduces the workload on human representatives.

In some embodiments, affordable housing application 128 may include additional functions and features such as, but not limited to, automated, pre-set calls, emails, instant messages, texts, and other types of communication pertaining to process status, income, assets, or other issues associated with a certification 208. Further, affordable housing application 128 (in some examples, via AI model 250) may automatically communicate any detected errors (steps 2306 and 2308 of FIG. 23) to resident/applicant 202 or other parties via automated pre-set calls, emails, instant messages, texts, and other types of communication. In some embodiments, affordable housing application 128 may automate certification process 208 annually and 120 days (or another suitable period) before the certification deadline. Affordable housing application 128 may send automatic document update requests to property management 204 responsive to changes and updates provided by resident/applicant 202 regarding household, assets, income, or any other relevant factor.

Accordingly, affordable housing application 128 offers a multi-functional, complete system to assist in assembly and organization of all required documents for any type of certification 208 for a resident/applicant 202 of an affordable/low-income housing program 214. Affordable housing application 128 benefits multiple individuals including entities and companies that assist with affordable housing compliance. Affordable housing application 128 saves time, money, and resources, and allows parties to remotely communicate and coordinate all information and documents needed to complete a certification 208 using computing device 101 over network 142. There is no need for resident/applicant 202 and other parties to meet in person on every occasion that a signature is required, documents need to be shared, or another piece of information supplied.

In this description, the appended claims, and the accompanying drawings, reference is made to particular features (including method steps) of various embodiments. This disclosure encompasses all possible combinations of such features. For example, where a feature is disclosed in the context of a particular aspect or embodiment, or in the context of a particular claim, that feature may also be used in combination with or in the context of other aspects and embodiments of the disclosure.

The term “comprises” and its grammatical equivalents is used herein to mean that other components, ingredients, and steps, among others, are optionally present. For example, an article “comprising” components A, B, and C can contain only components A, B, and C, or may contain components A, B, and C and one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. A range given as “(a first number) to (a second number)” or “(a first number)−(a second number)” means a range whose lower limit is the first number and whose upper limit is the second number. For example, 25 to 100 mm means a range whose lower limit is 25 mm and upper limit is 100 mm.

Certain terminology and derivations thereof are used in this description for convenience only and are not limiting. For example, terms such as “upward,” “downward,” “left,” and “right” refer to directions in the drawings to which reference is made unless otherwise stated. Similarly, terms such as “inward” and “outward” refer to directions toward and away from, respectively, the geometric center of a device or area and designated parts thereof. References in the singular tense include the plural, and vice versa, unless otherwise noted. The term “coupled to” as used herein may refer to a direct or indirect connection. The term “set” as used herein may refer to one or more items.

The corresponding structures, materials, acts, and equivalents of all means or step plus function elements in the claims below are intended to include any structure, material, or act for performing the function in combination with other claimed elements as specifically claimed. This description is presented for purposes of illustration but is not exhaustive or limited to the form disclosed. Many modifications and variations will be apparent to those of ordinary skill in the art without departing from the scope and spirit of this disclosure.

The embodiments described herein were chosen to best explain the principles and practical application of this disclosure, and to enable those of ordinary skill in the art to practice embodiments with modifications suited to the particular use contemplated. This description is illustrative and not restrictive, and the embodiments described herein may be practiced with modification and alteration within the spirit and scope of the appended claims.

What is claimed is:

1. A system for digitally validating a certification remotely for an affordable/low-income housing program, the system comprising:
one or more processors; and
system memory coupled to the one or more processors and storing instructions configured to cause the one or more processors to implement all or part of an affordable/low-income housing application in the system memory, including:
present, via the one or more processors, one or more interfaces of the affordable/low-income housing application to a tenant and one or more other parties to electronically and remotely complete any type of certification in order to provide remote access over a network using one or more computing devices to the tenant to provide necessary information required to complete the any type of certification, wherein the one or more other parties further comprise property management and/or staff, compliance specialists, and/or administrators of the affordable/low-income housing application;
training a machine learning algorithm using labelled input training data and labelled output training data to produce an artificial intelligence (AI) model that detects errors or discrepancies in answers provided by a tenant;
determine what type of certification the tenant is eligible to participate in using user feedback and determining if the tenant has any prior certifications or if the tenant is participating in a move-in initial certification;
responsive to determining what type of certification the tenant is eligible to participate in, present, via the one or more processors, a pre-compiled list of questions/statements requesting information in an interface to the tenant, wherein the pre-compiled list of questions/statements requesting information corresponds to a set of fillable fields for one or more questions and/or requirements for a set of documents, questionnaires, forms, or other items to be submitted for a type of certification, wherein the type of certification comprises any one of an initial or move-in certification, an interim certification, a transfer certification, an annual certification, or a move-out certification;
receive, via the one or more processors, answers from the tenant to the pre-compiled list of questions/statements requesting information;
upon receiving, via the one or more processors answers from the tenant to the pre-compiled list of questions/statements requesting information, analyze, via the one or more processors, the received answers from the tenant for errors or discrepancies using the AI model associated with the affordable/low-income housing application that is trained to detect the errors or discrepancies in the received answers;
determine, via the one or more processors, whether the AI model found or flagged any the errors or discrepancies in the received answers from the tenant;
if one or more of the errors or discrepancies are found or flagged, automatically notify the tenant through an interface of the affordable/low-housing application of the errors or discrepancies in order to correct the received answers and execute and provide access via the affordable/low-income housing application to a digital report that compiles and lists the errors or discrepancies;
responsive to notifying the tenant through the interface of the affordable/low-housing application of the errors or discrepancies, present one or more second questions and/or statements corresponding to the pre-compiled list of questions and/or statements but in a different order and manner through the interface for the user to enter an updated set of tenant answers in response to the second questions and/or statements;
receive, via the one or more processors, the updated set of tenant answers;
extract, via the one or more processors, correct answers obtained from the updated set of tenant answers;
responsive to extracting the correct answers from the updated set of tenant answers, automatically, via the one or more processors, map and enter the correct answers to corresponding fillable fields from the set of fillable fields for the one or more questions and/or requirements for the set of documents, questionnaires, forms, or other items;
automatically initiate a certification process to verify eligibility of the tenant to remain in the type of certification upon receiving any notification of household changes from the tenant through the affordable/low-income housing application after the tenant has been certified at least once, further comprising, reviewing changes made to a household of the tenant and notifying a client if eligible to remain in the type of certification;
using the AI model, review the updated set of tenant answers to determine whether third party verifications and third party documentation relating to the tenant's employment, financial status, student status, or other matters are required for the type of certification;
verify whether all the third party verifications and the third party documentation have been provided accurately;
if the third party verifications and the third party documentation have not been provided, retrieve from a database valid third party contacts and auto-send to request the third party verifications and third party documentation relating to the tenant's employment, financial status, or other matters;
send verification documents through the affordable/low-housing application to the third party contacts to provide third party verifications and third party documentation;
store any received third party verifications and third party documentation directly in the affordable/low-income housing application and indicate a status of level of completion for the third party verifications and third party including indicating whether the third party documentation relate to income verification or asset verification or employment verification and labeling each document visually according to a determination related to whether the third party documentation qualifies as the income verification, the asset verification, or the employment verification;
display in a graphical user interface relevant data for documents that relate to required asset verification, income verification, and employment verification, further comprising, displaying in the graphical user interface a name of each document, a type of certification and whether the document relates to an initial certification, an annual certification, an interim certification, a transfer certification, or a move out certification, listed recipients who can access the document, a status associated with approval and/or completion or action still required for the document, and an ability to edit a document using the graphical user interface;
assemble, via the one or more processors, a completed set of documents, questionnaires, forms, or other items to be submitted for the type of certification; and
store, via the one or more processors, the completed set of documents, questionnaires, forms, or other items to be submitted for the type of certification for future auditing conducted by a representative/agent of the affordable/low-income housing program.

2. The system of claim 1, wherein the AI model is trained on standards and requirements of the affordable/low-income housing program and automatically determines eligibility of a household by applying the standards and requirements to the received answers.

3. The system of claim 1, wherein the AI model automatically notifies any third party that needs to provide third party verifications and documentation.

4. The system of claim 1, wherein the AI model analyzes household changes and if appropriate automatically initiates the certification process.

5. The system of claim 1, wherein the AI model serves as an interactive guide, offering users guidance on the affordable/low-income housing program.

6. The system of claim 1, wherein the machine learning algorithm comprises a recurrent neural network (RNN) with long short-term-memory (LSTM) cells.

7. The system of claim 1, wherein the machine learning algorithm comprises a regression model that infers annual income based on pay frequencies and pay rates and to assess eligibility against housing program requirements.

8. A system for validating a remote certification for a housing program, comprising:
a processor; and
a memory coupled to the processor and storing instructions configured to cause the processor to implement a housing application, the instructions comprising:
presenting, by the processor, an interface of the housing application to an applicant to enable the applicant to provide information required to complete the certification;
training a machine learning algorithm using labelled input training data and labelled output training data to produce an artificial intelligence (AI) model that detects errors or discrepancies in answers provided by the applicant and third parties;
determining a type of certification that the applicant is eligible for and determining whether the applicant has a prior certification or is seeking an initial certification;
presenting, by the processor, questions to the applicant that correspond to fillable fields in associated questionnaires, forms, or documents;
receiving, by the processor, the answers from the applicant to the questions;
analyzing, by the AI model, the answers for errors or discrepancies;
determining, by the processor, whether the AI model found any errors or discrepancies;
if errors or discrepancies are found, notifying the applicant of the errors or discrepancies and providing a report that lists the errors or discrepancies;
presenting, by the processor, second questions to the applicant that correspond to the fillable fields in the associated questionnaires, forms, or documents but in a different order or manner;
receiving, by the processor, updated answers to the second questions from the applicant;
extracting, by the processor, correct answers from the updated answers;
mapping, by the processor, the correct answers to the fillable fields in the associated questionnaires, forms or documents;
initiating, by the AI model, a certification process to verify continued eligibility for the certification after receiving a notification of a household change from the applicant;
reviewing, by the AI model, the household change and notifying the applicant whether the applicant has continued eligibility for the certification;
reviewing, by the AI model, the updated answers to determine whether verification or documentation of a third party is required for the certification;
if the verification or documentation of the third party is required, verifying, by the processor, whether the verification or documentation has been provided;
if the verification or documentation of the third party has not been provided, sending requests to the third party for the verification or documentation;
storing, by the processor, the verification or documentation of the third party, and labeling the verification or documentation relating to income verification, asset verification, or employment verification;
for a document labeled as relating to asset verification, income verification, or employment verification, displaying in the interface a name of the document, the type of certification, individuals who can access the document, a status of the document, and an ability to edit the document;
assembling, via the processor, a completed set of questionnaires, forms, or documents to be submitted for the certification; and
storing, via the processor, the completed set of questionnaires, forms, or documents for future auditing.

9. The system of claim 8, wherein the AI model is trained on standards and requirements of the housing program and automatically determines eligibility of a household by applying the standards and requirements to the answers of the applicant.

10. The system of claim 8, wherein the AI model automatically notifies the third party that the verification and documentation of the third party is required.

11. The system of claim 8, wherein the AI model analyzes household changes and if appropriate automatically initiates the certification process.

12. The system of claim 8, wherein the AI model serves as an interactive guide, offering users guidance on the housing program.

13. The system of claim 8, wherein the machine learning algorithm comprises a recurrent neural network (RNN) with long short-term-memory (LSTM) cells.

14. The system of claim 8, wherein the machine learning algorithm comprises a regression model that infers annual income based on pay frequencies and pay rates and to assess eligibility against housing program requirements.

15. A system for validating a certification for a housing program, comprising:
a processor; and
a memory coupled to the processor and storing instructions configured to cause the processor to implement a housing application, the instructions comprising:
presenting, by the processor, an interface of the housing application to an applicant to enable the applicant to provide information required to complete the certification;
training a machine learning algorithm using labelled input training data and labelled output training data to produce an artificial intelligence (AI) model that detects errors or discrepancies in answers provided by the applicant;
presenting, by the processor, questions to the applicant that correspond to fillable fields in associated documents;
receiving, by the processor, answers from the applicant to the questions;
analyzing, by the AI model, the answers for errors or discrepancies;
if errors or discrepancies are found, notifying the applicant of the errors or discrepancies;
presenting, by the processor, second questions to the applicant that correspond to the fillable fields in the associated documents but in a different order or manner;
receiving, by the processor, updated answers to the second questions from the applicant;
extracting, by the processor, correct answers from the updated answers;
mapping, by the processor, the correct answers to the fillable fields in the associated documents;
initiating, by the AI model, a certification process to verify continued eligibility for the certification after receiving a notification of a household change from the applicant;
reviewing, by the AI model, the household change and notifying the applicant whether the applicant has continued eligibility for the certification; and
reviewing, by the AI model, the updated answers to determine whether verification or documentation of a third party is required for the certification.

16. The system of claim 15, wherein the AI model is trained on standards and requirements of the housing program and automatically determines eligibility of a household by applying the standards and requirements to the answers of the applicant.

17. The system of claim 15, wherein the AI model automatically notifies the third party that the verification and documentation of the third party is required.

18. The system of claim 15, wherein the AI model analyzes household changes and if appropriate automatically initiates the certification process.

19. The system of claim 15, wherein the AI model serves as an interactive guide, offering users guidance on the housing program.

20. The system of claim 15, wherein the machine learning algorithm comprises a recurrent neural network (RNN) with long short-term-memory (LSTM) cells and a regression model that infers annual income based on pay frequencies and pay rates and to assess eligibility against housing program requirements.
